(19) United States
(12) Patent Application Publication
(10) Pub. No.: US 2024/0388208 A1
(43) Pub. Date: Nov. 21, 2024

(54) REGULATION SYSTEM FOR A MULTI-ACTIVE BRIDGE CONVERTER WITH HYBRID SUPPLY, ASSOCIATED METHOD AND DEVICE

(71) Applicants: Commissariat à l'énergie atomique et aux énergies alternatives, Paris (FR); UNIVERSITE GRENOBLE ALPES, Saint Martin D'heres (FR); Centre national de la recherche scientifique, Paris (FR); INSTITUT POLYTECHNIQUE DE GRENOBLE, Grenoble (FR)

(72) Inventors: Rebecca TARRAF, Grenoble Cedex 9 (FR); David FREY, Saint Martin D'heres (FR); Sylvain LEIRENS, Grenoble Cedex 9 (FR); Sébastien CARCOUET, Grenoble Cedex 9 (FR); Xavier MAYNARD, Grenoble Cedex 9 (FR)

(73) Assignees: Commissariat à l'énergie atomique et aux énergies alternatives, Paris (FR); UNIVERSITE GRENOBLE ALPES, Saint Martin D'heres (FR); Centre national de la recherche scientifique, Paris (FR); INSTITUT POLYTECHNIQUE DE GRENOBLE, Grenoble (FR)

(21) Appl. No.: 18/660,472

(22) Filed: May 10, 2024

(30) Foreign Application Priority Data
May 11, 2023 (FR) 2304696

(51) Int. Cl. H02M 3/335

(52) U.S. Cl. CPC H02M 3/33573; H02M 3/33576

(57) ABSTRACT

The present invention [relates to] a regulation system (28) for a multi-active bridge converter (10) with hybrid supply, comprising:
an input current port (20) comprising an H-shape switch bridge (30) having a switch (T₁) controlled by a first law having a first duty cycle,
at least one output voltage port (22, 24) comprising an H-shape switch bridge (38, 40), one switch (T 21, T 31) of which is controlled by a second law which is phase-shifted with respect to the first law,
the regulation system (28) regulates the converter (10) to a setpoint comprising a setpoint current value for the current of the current port (20) and a setpoint voltage value for a voltage port (22, 24).

This patent application claims the benefit of document FR23/04696 filed on May 11, 2023 which is hereby incorporated by reference.

### FIELD OF THE INVENTION

The present invention relates to a regulation system for a multi-active bridge converter with hybrid supply. The invention further relates to an associated regulation method and converter.

### TECHNOLOGICAL BACKGROUND OF THE INVENTION

The integration of renewable energy sources and energy storage systems into electronic power applications has generated interest in multiport converters.

A specific topology of such converters is that of MAB converters, the acronym MAB referring to the English name “Multi-Active Bridge”.

An example of using such a converter is shown in FIG. 1 where the converter interacts with the grid, a battery, a load (resistor in the figure) and a solar panel.

It is thus shown that such a structure has the advantage that the production, consumption and the storage of electrical energy can be carried out in one place.

Furthermore, MAB converters have intrinsic galvanic isolation because the transformer connects the ports via respective windings. Such aspect is important to make possible the use of converters for sources of energy and load which have very significant differences.

It is known to use MAB converters with voltage ports.

However, for certain uses and in particular for cases of photovoltaic panels, it is desirable to use bridges supplied with current, which leads to a converter with hybrid supply, the surge control of which is difficult.

### SUMMARY OF THE INVENTION

Therefore, to ensure a proper operation of the converter, there is a need for a regulation system for a multi-active bridge converter with hydride supply.

To this end, the description describes a regulation system for a multi-active bridge converter with hydride supply, the active multi-bridge converter comprising:
a port for input current, comprising an H-shaped switch bridge for which a reference switch is defined, the reference switch being called the first reference switch and being controlled by a first control law, the first control law having a first duty cycle,
at least one port for output voltage, comprising an H-shaped switch bridge for which a reference switch is defined, each reference switch being called the second reference switch and being controlled by a respective second control law, each second control law having a second predefined duty cycle and a phase shift with respect to the first control law,
a transformer with windings, each winding being connected to a port via a respective isolation interface,
   the regulation system being suitable for setting the active multi-bridge converter to a setpoint, the setpoint comprising a setpoint current value for the current of the current port and at least one setpoint voltage value for a voltage port, the regulation system comprising:
a measuring unit for measured values, the measured values comprising the current of the current port and the voltage of each voltage port,
a first control unit of the first reference switch, the first control unit comprising:
   a first subunit for calculating a first desired initial value, the first desired initial value being a desired value for the first duty cycle equal to the sum of the result of a first calculation function applied to the setpoint values and of a safety margin,
   a first determination subunit for determining the difference between the measured current value and the setpoint current value, in order to obtain a determined difference of current,
   a first correction subunit apt to convert the determined difference of current into a first corrective value for the first duty cycle by applying a first conversion function,
   a first addition subunit for adding the first desired initial value and the first corrective value, so as to obtain a first candidate value,
   a first adjustment subunit suitable for adjusting the first candidate value so as to obtain a first value to be applied, comprised between two first extreme values, the first lowest extreme value being the result of the first calculation function applied to the measured values,
   a first subunit of application of the first control law having as duty cycle the first value to be applied, and
for each voltage port having a setpoint voltage value, a second control unit of the second reference switch of the voltage port in question, each second control unit comprising:
   a second calculation subunit for calculating a second desired initial value, the second desired initial value being a desired value for the phase shift equal to the result of a second calculation function applied to the first desired initial value,
   a second determination subunit for determining the difference between the measured voltage value for the voltage port in question and the set voltage value for the voltage port in question, in order to obtain a determined difference of voltage,
   a second correction subunit apt to convert the determined difference of voltage into a second corrective value for the phase shift by applying a second conversion function,
   a second addition subunit for adding the second desired initial value and of the second corrective value, so as to obtain a second candidate value,
   a second adjustment subunit suitable for adjusting the second candidate value so as to obtain a second value to be applied, comprised between two second extreme values, the second lowest extreme value being the result of the second calculation function applied to the first desired initial value, and
   a second application subunit for applying the second control law having as phase shift the second value to be applied.

According to particular embodiments, the regulation system has one or a plurality of the following features, taken individually or according to all technically possible combinations:
each adjustment subunit is apt to give, as value to be applied, the candidate value unchanged when the candidate value is comprised between the two extreme values and otherwise the extreme value closest to the candidate value.
the second highest extreme value is the result of a third calculation function applied to the first desired initial value.
at least one calculation function among the second calculation function and the third calculation function is an affine function.
each correction subunit is an integral proportional corrector.
each conversion function is a first order function.
each H-shape bridge has two midpoints, each isolation interface having two lines connecting a respective midpoint with one end of the associated winding, one of the two lines having a resistor in series with an inductance.
each winding has turns, the first conversion function having a gain dependent on the measured values of the voltages, the second desired initial value, the number of turns of each winding and the inductances of the isolation interfaces.
each winding has turns, the second conversion function having a gain dependent on the measured current value, on the first desired initial value, on the second desired initial value, on the number of turns of each winding and on the inductances of the isolation interfaces.
each winding has turns, the first calculation function depending, in addition, on the number of turns of each winding and on the inductances of the isolation interfaces.
an output voltage port is a bi-directional port.
each determination subunit is a subtractor.
the safety margin is a predefined value.

The description further describes an active multi-bridge converter with hybrid supply, the active multi-bridge converter comprising:
a port for input current operating at a current, comprising an H-shaped switch bridge for which a reference switch is defined and operating at a current, the reference switch being called the first reference switch and being controlled by a first control law, the first control law having a first duty cycle,
at least one port for output voltage operating at a voltage, each voltage port comprising an H-shaped switch bridge for which a reference switch is defined, each reference switch being called the second reference switch and being controlled by a respective second control law, each second control law having a second predefined duty cycle and a phase shift with respect to the first control law,
a transformer with windings, each winding being connected to a port by a respective isolation interface, and
a regulation system as described hereinabove.

The description further proposes a regulation method of regulating a multi-active bridge converter, the multi-active bridge converter comprising:
a port for input current, comprising an H-shaped switch bridge for which a reference switch is defined, the reference switch being called the first reference switch and being controlled by a first control law, the first control law having a first duty cycle,
at least one port for output voltage, comprising an H-shaped switch bridge for which a reference switch is defined, each reference switch being called the second reference switch and being controlled by a respective second control law, each second control law having a second predefined duty cycle and a phase shift with respect to the first control law,
a transformer with windings, each winding being connected to a port via a respective isolation interface,
   the method being suitable for setting the active multi-bridge converter to a setpoint, the setpoint comprising a setpoint current value for the current of the current port and at least one setpoint voltage value for a voltage port, the method comprising the steps of:
measurement of measured values, the measured values comprising the current of the current port and the voltage of each voltage port,
control of the first reference switch, the control step comprising:
   a first calculation of a first desired initial value, the first desired initial value being a desired value for the first duty cycle equal to the sum of the result of a first calculation function applied to the set values and of a safety margin,
   a first determination of the difference between the measured current value and the setpoint current value, so as to obtain a determined difference of current,
   a first correction converting the determined difference of current into a first corrective value for the first duty cycle by applying a first conversion function,
   a first addition of the first desired initial value and of the first corrective value, so as to obtain a first candidate value,
   a first adjustment suitable for adjusting the first candidate value so as to obtain a first value to be applied, comprised between two first extreme values, the first lowest extreme value being the result of the first calculation function applied to the measured values,
   a first application of the first control law having as duty cycle the first value to be applied, and
for each voltage port having a setpoint voltage value, control of the second reference switch of the voltage port in question, each control step of the second switch comprising:
   a second calculation of a second desired initial value, the second desired initial value being a desired value for the phase shift equal to the result of a second calculation function applied to the first desired initial value,
   a second determination of the difference between the measured voltage value for the voltage port in question and the reference voltage value for the voltage port in question, so as to obtain a determined difference of voltage,
   a second correction converting the determined difference of voltage into a second corrective value for the phase shift by applying a second conversion function,
   a second addition of the second desired initial value and the second corrective value, so as to obtain a second candidate value,
   a second adjustment subunit suitable for adjusting the second candidate value so as to obtain a second value to be applied, comprised between two second extreme values, the second lowest extreme value being the result of the second calculation function applied to the first desired initial value, and
   a second application of the second control law having as phase shift the second value to be applied.

In the present description, the expression “suitable for” means equally well “apt to” or “configured for”.

### BRIEF DESCRIPTION OF DRAWINGS

The features and advantages of the invention will appear upon reading the following description, given only as an example, but not limited to, and making reference to the enclosed drawings, wherein:

FIG. 1 is a schematic representation of an example of use of a multi-active bridge converter with hybrid supply,

FIG. 2 is an electrical diagram of an example of a multi-active bridge converter with hybrid supply, the converter comprising a regulation system,

FIG. 3 shows a diagram of part of the regulation system,

FIG. 4 shows a diagram of another part of the regulation system,

FIG. 5 shows the change of the input and output signals of the converter shown in FIG. 2 in an ideal operation,

FIG. 6 schematically illustrates the star-delta conversion, and

FIGS. 7 to 10 show simulation results obtained by the applicant.

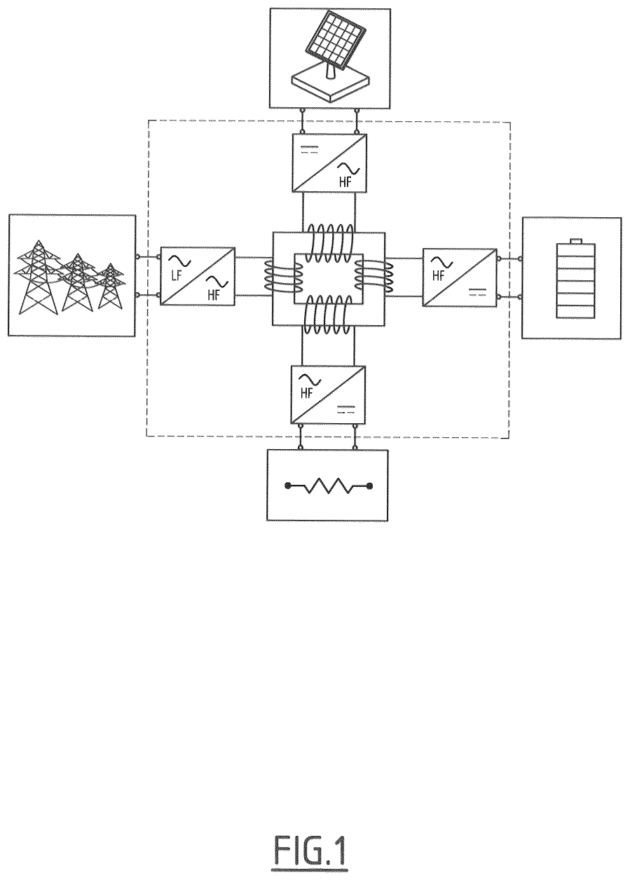

### DETAILED DESCRIPTION OF PREFERRED EMBODIMENTS

According to the example described, the multi-active bridge converter 10 with hybrid supply comprises three ports 20, 22 and 24, a transformer 26 and a regulation system 28.

In this sense, the converter 10 is a triple active bridge converter.

Such a converter 10 is sometimes referred to as a TAB converter, the acronym “TAB” being the acronym for “Triple Active Bridge”.

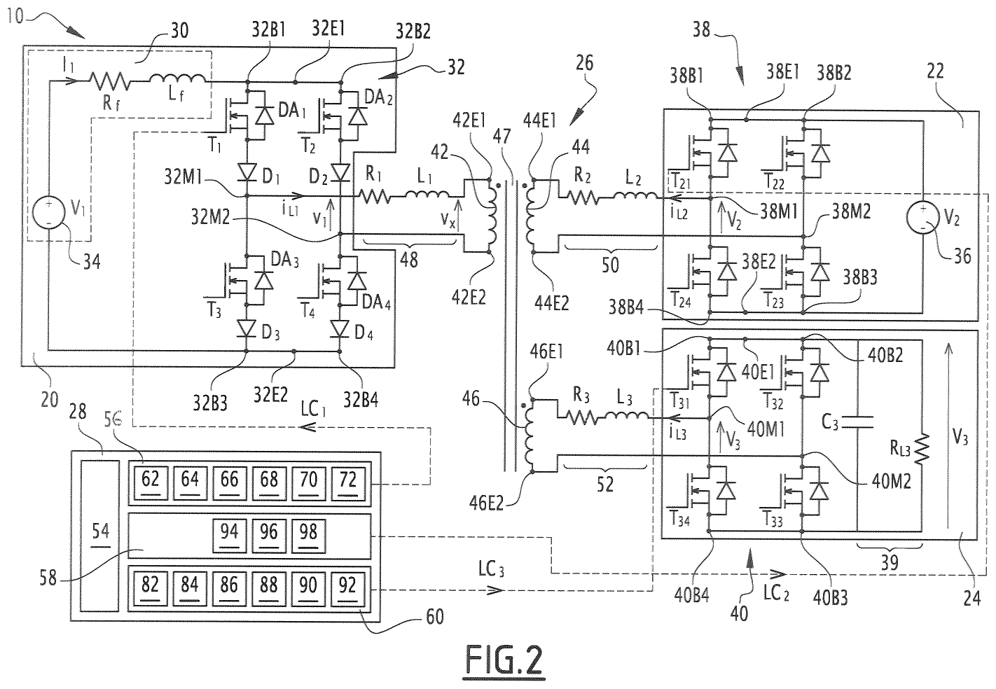

According to the example shown in FIG. 2, the converter 10 includes an input current port 20, a first voltage port 22 and a second output voltage port 24.

The first voltage port 22 is herein both an input port and an output port (bidirectional character).

Such a converter 10 can, e.g., be used to connect a photovoltaic module to the input current port 20, a battery to the first voltage port 22 and a direct current load to the second output voltage port 24.

In such a case, the input current reference of the input current port 20 would correspond to the tracking of the maximum power point of the photovoltaic module. The tracking is often referred to by the abbreviation MPPT (Maximum Power Point Tracker).

The current port 20 includes a current source 30 and a first H-shape switch bridge 32.

The current source 30 is apt to deliver a current denoted hereafter by I₁.

The current source 30 comprises a voltage generator 34, a resistor R_{f} and an inductance L_{f} in series.

In each of the following notations, to make reading easier, the reference sign of a component may correspond to the value thereof. Typically, the resistance of the current source 30 is denoted by the reference sign R_{f} and the value of the resistance is denoted by R_{f}.

The voltage generator 34 produces a voltage V₁.

The voltage generator 34 has a positive pole and a negative pole.

The current source 30 is suitable for operating at a current determining the operating current of the current port 20.

The current port 20 is a unidirectional port.

The above means that the current port 20 is only suitable for sending power to the transformer 26.

To simplify the notations, each H-shape switch bridge will be referred to as an H-bridge.

The first H-bridge 32 has four branches 32B1 to 32B4, a first end 32E1 and a second end 32E2 and two midpoints 32M1 and 32M2.

The first branch 32B1 extends between the first end 32E1 and the first midpoint 32M1, the second branch 32B2 extends between the first end 32E1 and the second midpoint 32m2, the third branch 32B3 extends between the first midpoint 32M1 and the second end 32E2 and the fourth branch 32B4 extends between the second midpoint 32m2 and the second end 32E2.

The first end 32E1 is connected to the inductance L_{f} of the current source 30 and the second end 32E2 is connected to the negative pole of the voltage generator 34.

As its name “switch bridge” indicates, each branch 32B1 to 32B4 of the first H-bridge 32 includes a switch T₁ to T₄, respectively.

Herein, each switch is a transistor.

Furthermore, because each switch of an H-bridge in the example described has an on/off operation, hereinafter in the description, the term switch will refer to transistors. Nevertheless, what will be described is valid more generally for a switch instead of a switch.

Furthermore, each branch 32B1 to 32B4 of the first H-bridge 32 includes two diodes, a diode DA1 to DA4 in parallel with the switch T₁ to T₄ and a diode D1 to D4 in series with the switch T₁ to T₄.

Furthermore, the first switch T₁ is defined as the reference switch of the current port 20 and will be referred hereinafter to as the first reference switch T₁.

The first reference switch T₁ of the current port 20 is controlled by a first control law LC₁. The first control law LC₁ has a first duty cycle denoted by D₁.

The fourth switch T₄ is controlled by the same first control law LC₁ while the second switch T₂ and the third switch T₃ are controlled by the same law phase shifted by 180° with respect to the first control law LC₁. The phase shift of 180° corresponds to a time shift of half the switching period T_{S}/2.

As such, it would be possible to apply what will be described by choosing one of the switches T₂, T₃ or T₄ as the first reference switch.

The first voltage port 22 includes a second voltage source 36 and a second H-bridge 38.

The first voltage port 22 operates at a voltage, called the second voltage V₂. The second voltage V₂ corresponds herein to the voltage delivered by the second voltage source 36.

The first voltage port 22 is a bidirectional port.

The above means that the first voltage port 22 receives from the transformer 26 and delivers power through the transformer 26.

The second H-bridge 38 has a structure similar to the structure of the first H-bridge 30 (the bridge of the current port 20) with four branches 38B1 to 38B4, ends 38E1 and 38E2 and two midpoints 38M1 and 38M2.

In the case shown, each branch 38B1 to 38B4 of the second H-bridge 38 further includes a transistor and a diode in parallel, similar to the branches of the first H-bridge 30 but does not include any diode in series.

Thereafter, the transistor of a branch 38Bi of the second H-bridge 38 is denoted by T₂ᵢ.

The first end 38E1 of the second H-bridge 38 is connected to the positive pole of the second voltage source 36 and the second end 38E2 of the second H-bridge 38 is connected to the negative pole of the second voltage source 36.

Furthermore, the first switch T₂₁ is defined as the reference switch of the first voltage port 22, which will hereinafter be the second reference switch T₂₁ so as to avoid any confusion with the first reference switch T₁.

The second reference switch T₂₁ of the first voltage port 22 is controlled by a second control law LC₂.

The second control law LC₂ has a second duty cycle denoted by D₂ and a phase shift denoted as second φ₂ with respect to the first control law LC₁.

Thereafter, the second duty cycle denoted by D₂ is set at a predefined value, chosen in a non-limiting manner herein as equal to 0.5.

The second voltage port 24 includes a load 39 and a third H-bridge 40.

The load 39 comprises a capacitor C₃ in parallel with a resistor R_{L3}.

The second voltage port 24 operates at a voltage, called the third voltage V₃. The third voltage V₃ corresponds herein to the voltage at the terminals of resistor R_{L3}.

The second voltage port 24 is a unidirectional port.

The above means that the second voltage port 24 receives power coming from the transformer 26.

The third H-bridge 40 has a structure similar to the structure of the second H-bridge 38 (the bridge of the first voltage port 22) with four branches 40B1 to 40B4, ends 40E1 and 40E2 and two midpoints 40M1 and 40M2.

In the case shown, each branch 40B1 to 40B4 includes the same components as the branches 38B1 to 38B4 of the third H-bridge 38, namely a transistor and a diode in parallel.

Thereafter, the transistor of a branch 40B1 to 40B4 of the third H-bridge 40 is denoted by T₃ᵢ.

The first end 40E1 of the third H-bridge 40 is connected to a terminal of the capacitor C₃ and a terminal of the resistor R_{L3} so that the second end 40E2 of the third H-bridge 40 is connected to another terminal of the capacitor C₃ and another terminal of resistor R_{L3}.

Furthermore, the first switch T₃₁ is defined as the reference switch of the second voltage port 24, which will hereinafter be the third reference switch T₃₁, to avoid any confusion with the other reference switches T₁ and T₂₁.

The third reference switch T₃₁ of the second voltage port 24 is controlled by a third control law LC₃.

The third control law LC₃ has a third duty cycle denoted by D₃ and a phase shift, denoted as third phase shift V₃, with respect to the first control law LC₁.

Thereafter, the third duty cycle denoted by D₃ is set at a predefined value, chosen in a non-limiting manner herein as equal to 0.5.

The transformer 26 has windings 42, 44 and 46 connected by a core 47.

Each winding 42, 44 and 46 is connected to a port 20 to 24 by a respective isolation interface 48 to 52.

More precisely, the transformer 26 has a first winding 42 connected to the current port 20 by a first isolation interface 48, a second winding 44 connected to the first voltage port 22 by a second isolation interface 50 and a third winding 46 connected to the second voltage port 24 by a third isolation interface 52.

Each winding is a set of turns extending between a first end denoted by XE1 (where X is the reference sign of the winding considered) and a second end XE2.

The first isolation interface 48 comprises a first inductance L₁ in series with a first resistor R₁.

The first midpoint 32M1 of the first H-bridge 32 is connected to the first resistor R₁ and the second midpoint 32M2 of the first H-bridge 32 is connected to the second end 42E2 of the first winding 42.

The second isolation interface 50 comprises a second inductance L₂ in series with a second resistor R₂.

The first midpoint 38M1 of the second H-bridge 38 is connected to the inductance L₂ and the second midpoint 38M2 of the second H-bridge 38 is connected to the second end 44E2 of the second winding 44.

The third isolation interface 52 comprises a third inductance L₃ in series with a third resistor R₃.

The first midpoint 40M1 of the third H-bridge 40 is connected to the third inductance L₃ and the second midpoint 40M2 of the third H-bridge 40 is connected to the second end 46E2 of the third winding 46.

In each of the isolation interfaces 48, 50 or 52, the resistor R₁, R₂ or R₃ and the inductance L₁, L₂ or L₃ are same of the associated windings 42, 44 or 46. As such, the resistor R₁, R₂ or R₃ corresponds to a spurious resistor.

In some embodiments, the resistors or inductances come from external components.

The regulation system 28 is apt to regulate the multi-active bridge converter 10 to a setpoint.

In the present case, the setpoint is a setpoint current value for the current of the current port 20 and a setpoint voltage value for the second voltage port 24.

In fact, in the example described, the first voltage port 22 has no setpoint. The voltage of the first voltage port 22 is imposed by the voltage value V2 delivered by the second voltage source 36 and the current thereof is imposed by the fact that the algebraic sum of the incoming and outgoing converter powers 10 is zero.

The setpoint current value is denoted by I_{1,ref}, and the setpoint voltage value for the second voltage port 24 is denoted by V_{3,ref}.

The regulation system 28 ensures that at any time, the operation of the converter 10 does not damage any component of the converter 10.

The different conditions are discussed in detail in the Appendix part.

The regulation system 28 comprises a measuring unit 54, a first control unit 56, a second control unit 58 and a third control unit 60.

The measuring unit 54 is suitable for measuring a plurality of values of the converter 10.

According to the example described, the measured values comprise the current I₁ of the current port 20 and the voltage V₂ and V₃ of each voltage port 22 and 24.

The measuring unit 54 is connected to the other control units 56 to 60 in order to communicate the measured values thereto.

The first control unit 56 is apt to control the first reference transistor T₁ by means of a first suitable control law LC₁.

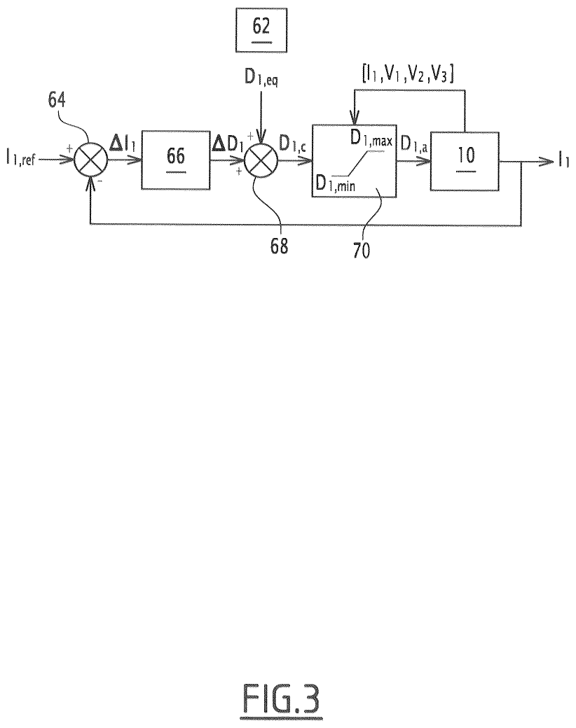

As can be seen in FIGS. 2 and 3, the first control unit 56 includes a first calculation subunit 62, a first determination subunit 64, a first correction subunit 66, a first addition subunit 68, a first adjustment subunit 70 and a first application subunit 72.

The first calculation subunit 62 is apt to calculate a first desired initial value denoted by D_{1,eq}.

To this end, the first calculation subunit 62 applies a first calculation function FC1 to the set values and then adds a safety margin ϵ to the result.

The first calculation function FC1 depends, in addition, on the number of turns of each winding 42 to 46 and on the inductance of the isolation interfaces 48 to 52.

The result of the first calculation function FC1 is denoted by D_{1,min_ref}.

The first calculation function FC1 is such that:

$${D}_{1 , min \_ ref} = \frac{2 {L}_{1} {I}_{1 , ref}}{( {L}_{b} \cdot {V}_{2 , r e f} \cdot \frac{{n}_{1}}{{n}_{2}} + {L}_{c} \cdot {V}_{3 , r e f} \cdot \frac{{n}_{1}}{{n}_{3}} ) \cdot {T}_{s}} + \frac{1}{2}$$

where:
n₁ is the number of turns of the first winding 42,
n₂ is the number of turns of the second winding 44,
n₃ is the number of turns of the third winding 46,

$${L}_{b} = \frac{\frac{1}{\frac{1}{{L}_{1}} + \frac{1}{{L}_{3}^{′}}}}{{L}_{2}^{′} + \frac{1}{\frac{1}{{L}_{1}} + \frac{1}{{L}_{3}^{′}}}} , with {L}_{k}^{′} = {( \frac{{n}_{1}}{{n}_{k}} )}^{2} {L}_{k} k = 1 , 2 or 3$$

$${L}_{c} = \frac{\frac{1}{\frac{1}{{L}_{1}} + \frac{1}{{L}_{2}^{′}}}}{{L}_{3}^{′} + \frac{1}{\frac{1}{{L}_{1}} + \frac{1}{{L}_{2}^{′}}}} ,$$

and
Tₛ is the switching period corresponding to the inverse of the chosen conversion frequency fₛ 1.

Once the value D_{1,min_ref} is obtained, one has:

$${D}_{1 , eq} = {D}_{1 , min \_ ref} + ϵ$$

According to the example described the safety margin ϵ is a predefined value, e.g. set at 0.01.

According to a more elaborate variant, the safety margin ϵ takes into account other elements such as variations in voltage sources or uncertainty about the value of inductances.

The first determination subunit 64 is apt to determine the difference between the measured current value I₁ and the reference current value I_{1,ref}.

The first determination subunit 64 is, herein, a subtractor.

The first determination subunit 64 thereby obtains the determined difference of current, denoted by ΔI₁ and which thus satisfies:

$$Δ {I}_{1} = {I}_{1 , r e f} - {I}_{1}$$

The first correction subunit 66 is apt to convert the determined difference of current ΔI₁ into a first corrective value for the first duty cycle.

The first corrective value is denoted by ΔD₁.

To obtain the first corrective value ΔD₁, the first correction subunit 66 applies a first conversion function to the determined difference of current ΔI₁.

The first conversion function is denoted by Gᵢ₁_{ᵣ}.

The first conversion function Gᵢ₁_{ᵣ} is herein a first order function.

More specifically, the first conversion function Gᵢ₁_{ᵣ} has a gain dependent on the measured values for the voltages, on the second desired initial value, on the number of turns of each winding 42 to 46 and on the inductance of the isolation interfaces 48 to 52.

According to the example described, the first conversion function Gᵢ₁_{ᵣ} is such that:

$${{G}_{i {1}_{r}} ( s ) = \frac{{I}_{1} ( s )}{{D}_{1} ( s )} \vert}_{\begin{matrix}\begin{matrix}{\hat{φ}}_{2} = 0 \\ {\hat{φ}}_{3} = 0\end{matrix} \\ {\hat{V}}_{3} = 0\end{matrix}} = \frac{a}{( s + c )}$$

Where:
s is the Laplace variable,

$$a = \frac{2 {L}_{b}}{{L}_{f} \cdot ( 1 - {L}_{a} )} \cdot \frac{{n}_{1}}{{n}_{2}} \cdot {V}_{2} + \frac{2 {L}_{c}}{{L}_{f} \cdot ( 1 - {L}_{a} )} \cdot \frac{{n}_{1}}{{n}_{3}} \cdot {V}_{3 , r e f} ,$$

the notation \hat{ } means small variation around the equilibrium point,

$${L}_{a} = \frac{\frac{1}{\frac{1}{{L}_{2}^{′}} + \frac{1}{{L}_{3}^{′}}}}{{L}_{1} + \frac{1}{\frac{1}{{L}_{2}^{′}} + \frac{1}{{L}_{3}^{′}}}} ,$$

$$and c = \frac{{R}_{f}}{{L}_{f}} + \frac{4 {L}_{1}}{{L}_{f} \cdot ( 1 - {L}_{a} ) \cdot {T}_{s}} .$$

The first correction subunit 66 thereby forms an integral proportional corrector.

Alternatively, it is also possible for the first correction subunit 66 to use a more elaborate first correction function Gᵢ₁_{ᵣ₂} as proposed in the appendix part.

The first addition subunit 68 is suitable for obtaining a first candidate value D_{1,c} by adding the first desired initial value D_{1,eq} with the first corrective value ΔD₁.

One thereby has:

$${D}_{1 , c} = {D}_{1 , eq} + Δ {D}_{1}$$

The first adjustment subunit 70 is suitable for obtaining a first value to be applied D_{1,app}.

To this end, the first adjustment subunit 70 adjusts the first candidate value D_{1,c} so as to obtain the first value to be applied D_{1,app}.

The purpose of such adjustment is to ensure that the first value to be applied D_{1,app} is comprised between two first extreme values.

The first two extreme values are denoted by D_{1,min} and D_{1,max}.

The first extreme value D_{1,min} is the result of the first calculation function FC1 applied to the measured values according to the formula described hereinabove, i.e. one obtains:

$${D}_{1 , min} = \frac{2 {L}_{1} {I}_{1}}{( {L}_{b} \cdot {V}_{2} \cdot \frac{{n}_{1}}{{n}_{2}} + {L}_{c} \cdot {V}_{3} \cdot \frac{{n}_{1}}{{n}_{3}} ) \cdot {T}_{s}} + \frac{1}{2}$$

According to the example described, the first extreme value D_{1,max} is set to the maximum value for the first duty cycle, namely 1.

The first adjustment subunit 70 is suitable for giving as value to be applied, the candidate value unchanged when the candidate value is comprised between the two extreme values and otherwise the extreme value closest to the candidate value.

Otherwise formulated, one obtains:

$$\{ \begin{matrix}{D}_{1 , app} = {D}_{1 , c} si {D}_{1 , c} ∈ [ {D}_{1 , min} , {D}_{1 , max} ] \\ {D}_{1 , app} = {D}_{1 , min} if {D}_{1 , c} < {D}_{1 , min} \\ {D}_{1 , app} = {D}_{1 , max} if {D}_{1 , c} > {D}_{1 , max}\end{matrix}$$

A first control law to be applied is thereby obtained, the first control law having as the duty cycle the first value to be applied.

The first application subunit 72 is suitable for applying the first control law to be applied.

The second control unit 58 and the third control unit 60 control the second reference switch T₂₁ and the third reference switch T₃₁, respectively.

Since the third control unit 60 is the control unit including the most subunits because a setpoint is set for the third reference switch T₃₁, same is first described before the second control unit 58.

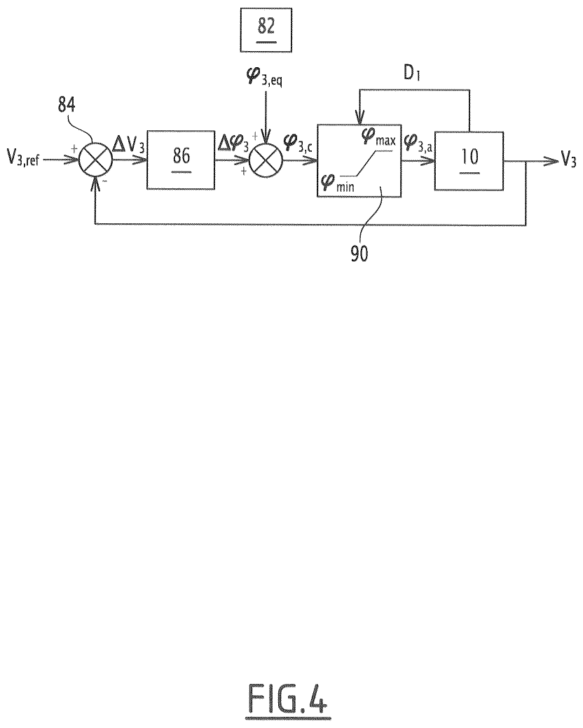

As can be seen in FIG. 4, the third control unit 60 includes a third calculation subunit 82, a third determination subunit 84, a third correction subunit 86, a third addition subunit, a third adjustment subunit 90 and a third application subunit 92.

The third calculation subunit 82 is suitable for calculating a third desired initial value denoted by φ_{3,eq}.

To this end, the third calculation subunit 82 applies a second calculation function FC2 to the first desired initial value D_{1,eq}.

The second calculation function FC2 is herein a function calculated from the mathematical model explained in the following part, at a certain operating point.

As it will emerge, the value φ_{3,eq} is obtained by solving a system of two equations with two unknowns once the value of the first duty cycle is set.

The third determination subunit 84 is apt to determine the difference between the measured voltage value V₃ for the second output voltage port 24 and the reference voltage value V_{3,ref} for the second output voltage port 24.

The third determination subunit 84 is, herein, a subtractor.

The third determination subunit 84 thereby obtains the determined difference of voltage, denoted by ΔV₃ and which thus satisfies:

$$Δ {V}_{3} = {V}_{3 , ref} - {V}_{3}$$

The third correction subunit 86 is apt to convert the determined difference of voltage ΔV₃ into a third corrective value for the third phase shift.

The third corrective value is denoted by Δφ₃.

To obtain the third corrective value Δφ₃, the third correction subunit applies a second conversion function to the determined difference of voltage ΔV₃.

The second conversion function is denoted by Gᵥ₃_{ᵣ}.

The second conversion function Gᵥ₃_{ᵣ} is herein a function of the first order.

More specifically, the second conversion function Gᵥ₃_{ᵣ} has a gain dependent on the measured current value of the first desired initial value, on the second desired initial value, on the number of turns of each winding 42 to 46, and on the inductance of the isolation interfaces 48 to 52.

According to the example described, the second transfer function Gᵥ₃_{ᵣ} is such that:

$${G}_{v {3}_{r}} ( s ) = \frac{{V}_{3} ( s )}{{φ}_{3} ( s )} {\vert}_{\begin{matrix}{\hat{φ}}_{2} = 0 \\ {\hat{D}}_{1} = 0\end{matrix}} = \frac{e}{( s + d )}$$

Where:

$$\begin{matrix}d = \frac{1}{{C}_{3} {R}_{L 3}} , and \\ e = \frac{4}{π {C}_{3}} \cdot \frac{{n}_{1}}{{n}_{3}} \cdot ( {I}_{13 , R , eq} \cdot sin ( {D}_{1 , eq} \cdot π + {φ}_{3 , eq} ) + {I}_{13 , I , eq} \cdot cos ( {D}_{1 , eq} \cdot π + {φ}_{3 , eq} ) + {I}_{23 , R , eq} \cdot sin ( {D}_{1 , eq} \cdot π + {φ}_{3 , eq} ) + {I}_{23 , I , eq} \cdot cos ( {D}_{1 , eq} \cdot π + {φ}_{3 , eq} ) )\end{matrix}$$

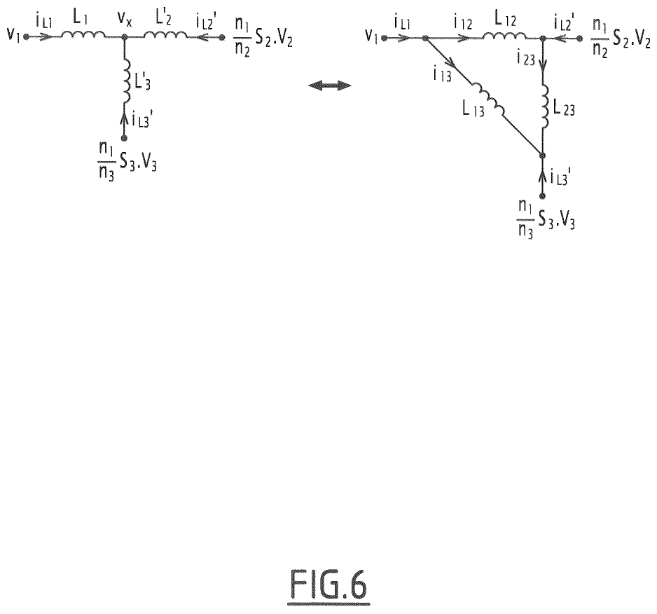

R as index denotes the actual value of the first harmonic (current herein),
I as index refers to the imaginary value,
I_{13,R,eq} is the current flowing through the inductance L₁₃ shown in FIG. 6 (see details with reference to the figure), and
I_{23,R,eq} is the current flowing through inductance L₂₃ in FIG. 6 (see details with reference to the figure).

The third correction subunit 86 thereby forms an integral proportional corrector.

The third addition subunit is suitable for obtaining a third candidate value φ_{3,c} by adding the third desired initial value φ_{3,eq} with the third corrective value Δφ₃.

One thereby has:

$${φ}_{3 , c} = {φ}_{3 , eq} + {Δφ}_{3}$$

The third adjustment subunit 90 is suitable for obtaining a third value to be applied φ_{3,app}.

To this end, the third adjustment subunit 90 adjusts the third candidate value φ_{3,c} so as to obtain the third value to be applied φ₃.

The purpose of such adjustment is to ensure that the third value to be applied φ_{3,a} is comprised between two third extreme values.

The two third extreme values are denoted by φ_{3,min} and φ_{3,max}.

Each of the third extreme values φ_{3,min} and φ_{3,max} is the result of applying a respective affine function applied to the first desired initial value D_{1,eq}.

More specifically, the third extreme value V_{3,min} is the result of the second calculation function FC2 applied to the first desired initial value D_{1,eq}, so that in the present case:

$${φ}_{3 , min} = π ( {D}_{1 , eq} - \frac{1}{2} )$$

For the third extreme value φ_{3,min} is the result of a third calculation function FC3 applied to the first desired initial value D_{1,eq}. The third calculation function FC3 is such that:

$${φ}_{3 , max} = π ( \frac{3}{2} - {D}_{1 , eq} )$$

The third adjustment subunit 90 is then suitable for giving as value to be applied, the candidate value unchanged when the candidate value is comprised between the two extreme values and otherwise the extreme value closest to the candidate value.

Otherwise formulated, one obtains:

$$\{ \begin{matrix}{φ}_{3 , app} = {φ}_{3 , c} si {φ}_{3 , c} ∈ [ {φ}_{3 , min} , {φ}_{3 , max} ] \\ {φ}_{3 , app} = {φ}_{3 , min} if {φ}_{3 , c} \leq {φ}_{3 , min} \\ {φ}_{3 , app} = {φ}_{3 , max} if {φ}_{3 , c} \geq {φ}_{3 , max}\end{matrix}$$

A third control law to be applied is thereby obtained, the third control law having as duty cycle the third predefined value and as phase shift the third value to be applied φ_{3,app}.

The third application subunit 92 is suitable for applying the third control law to be applied.

As regards the second control unit 58, compared with the other two control units 54 and 60, same operates in an open loop.

The above means that the second control unit 58 includes only a second calculation subunit 94, a second adjustment subunit 96 and an application subunit 98.

The operations of the second subunits 94, 96 and 98 are similar to the operations described for the corresponding third subunits (the subunits 82, 90 and 92).

Due to the open loop operation thereof, the second control unit 58 does not include any second subunits having the role of the third subunits.

As explained in the demonstration section, the regulation system 28 thereby ensures a stable operation of the converter 10 for any operating point.

Furthermore, the regulation system 28 can be applied to other configurations of the converter 10.

Examples of such configurations are given in Part 2 of the appendix.

### APPENDIX

### 1—General Case

### 1.1—Converter Topology

The converter 10 is a hybrid DC-DC multiport converter having a DC-AC current switch on the current port side and two voltage inverters on the voltage port side.

The abbreviation “DC” refers to “Direct Current” whereas the abbreviation “AC” refers to “Alternating Current”.

FIG. 2 shows the presence of a temporary current source 26 at the current port 20 (port 1) and of H-bridges 38 and 40 on the first voltage port 22 (port 2) and the second voltage port 24 (port 3). The current port 20 represents a power source (e.g. a photovoltaic module), the first voltage port 22 (port 2) is bidirectional (e.g. battery system and power grid), and the second voltage port 2 (port 3) is a DC load.

The ports 20, 22 and 24 of the converter 10 are coupled because of the presence of an inductance on each isolation interface 48 to 52, which may be either a leakage inductance of the transformer 26 alone or in series with an external inductance. Consequently, the converter 10 behaves like a multi-variable system having multiple inputs and multiple outputs (MIMO). In other words, changing a control parameter has an effect on the ports 20, 22 and 24 of the converter 10.

Controlling the power flow of the converter 10 can be achieved by regulating the input current i₁ of the current port 20 and the output voltage V₃ of the second voltage port 24.

Because the system is a coupled multiport converter 10, the algebraic sum of all the input and output powers of the system should be approximately equal to 0 (or equal to the losses of the system).

Thereby, the power flowing from and into the first voltage port 22 is imposed according to the following formula (neglecting the power stored in the magnetic core 47 of the transformer 26):

$${P}_{2} = - {P}_{1} - {P}_{3}$$

Where:
P₁ is the power flow flowing from and into the current port 20, and
P₃ is the power flow flowing from and into the second voltage port 24.

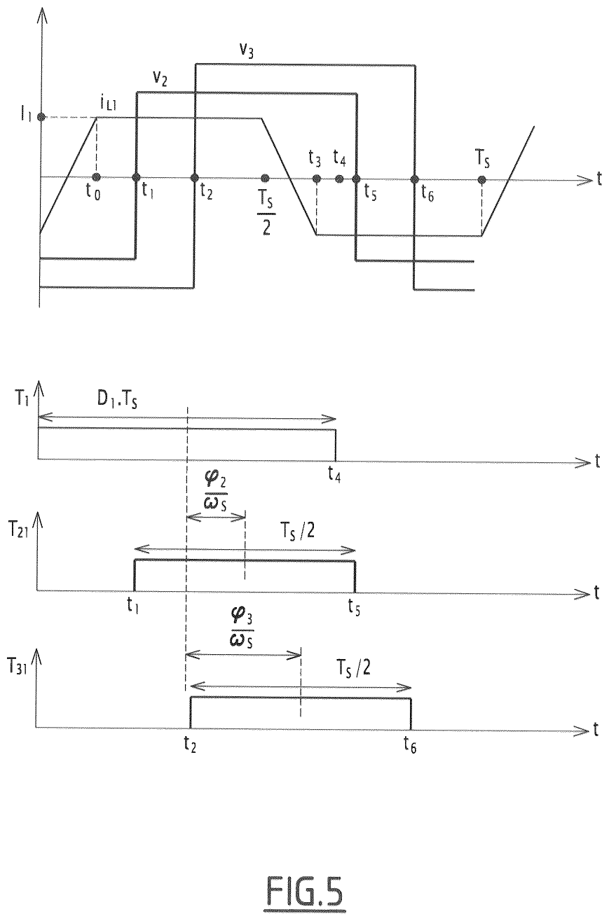

The waveform of the AC signals of the converter 10 circulating in the windings 42, 44, 46 of the transformer 26 can be seen in FIG. 5 as well as the control signals of the reference switches T₁, T₂₁, and T₃₁.

The trapezoidal shape of the change of the current i_{L1} shown in FIG. 5 corresponds to the current flowing in the first winding. The parameters v₂ and v₃ are the AC voltages on the transformer side 26 of the voltage ports 22 and 24, respectively. D₁ is the duty cycle of the control of the switches of the first current port 20 (0.5<D₁<1). φ₂ and φ₃ are the phase shifts (in radians) of the control signals of the reference switches T₂₁ and T₃₁, respectively, with respect to the reference switch T₁. The duty cycles of the controls of the switches of the voltage ports 22 and 24 are set at D₂=D₃=50% on the operating mode, so that the voltages v₂ and v₃ are the voltages visible in FIG. 5. Tₛ is the switching period (fₛ is the switching frequency).

The waveform shapes shown in FIG. 5 are an approximation of the actual shape of the signals. In reality, the current i_{L1} is not perfectly trapezoidal, as same is slightly affected by the switching of the voltage ports 22 and 24 at the instants t₁ and t₅ for the first voltage port 22 on one side, and t₂ and t₆ for the second voltage port 24 on the other side.

FIG. 6 shows the delta-star-delta equivalence of the windings of the transformer 26 at port 1, with v₂=S₂·V₂ and v₃=S₃·V₃·S₂ and S₃ the switching functions of ports 2 and 3, respectively. n₁, n₂ and n₃ denote the number of turns of each winding 42, 44 and 46, respectively, of the transformer 26.

In such equivalent circuits, the current port 20 is replaced by an equivalent voltage source. The expression of the voltage v₁ on the port at the transformer 26 is subsequently discussed in detail. The voltage at the point vₓ can be obtained by the following relationship R1:

$${v}_{x} = {L}_{a} \cdot {v}_{1} + {L}_{b} \cdot {v}_{2}^{′} + {L}_{c} \cdot {v}_{3}^{′}$$

Where:

$$\begin{matrix}{L}_{a} = \frac{\frac{1}{\frac{1}{{L}_{2}^{′}} + \frac{1}{{L}_{3}^{′}}}}{{L}_{1} + \frac{1}{\frac{1}{{L}_{2}^{′}} + \frac{1}{{L}_{3}^{′}}}} with {L}_{k}^{′} = {( \frac{{n}_{1}}{{n}_{k}} )}^{2} {L}_{k} \\ {L}_{b} = \frac{\frac{1}{\frac{1}{{L}_{1}} + \frac{1}{{L}_{3}^{′}}}}{{L}_{2}^{′} + \frac{1}{\frac{1}{{L}_{1}} + \frac{1}{{L}_{3}^{′}}}} , \\ {L}_{c} = \frac{\frac{1}{\frac{1}{{L}_{1}} + \frac{1}{{L}_{2}^{′}}}}{{L}_{3}^{′} + \frac{1}{\frac{1}{{L}_{1}} + \frac{1}{{L}_{2}^{′}}}} ,\end{matrix}$$

and
The inductances of the equivalent delta circuit are calculated as follows:

$${L}_{ij} = \{ \begin{matrix}NA , ∀ i = j \\ {L}_{i}^{′} + {L}_{j}^{′} + {L}_{i}^{′} {L}_{j}^{′} ( {\sum }_{k \neq i , j}^{n} \frac{1}{{L}_{k}^{′}} ) , ∀ i \neq j\end{matrix}$$

### 1.2—Principle of Operation

For a given operating point, the operating cycle of the converter 10 is divided into four successive time intervals.

The first time interval gathers instants t such as 0≤t≤t₀.

At the instant t=0, the switches T₁ and T₄ are set in the on state. The switches T₂ and T₃ are already in the on state (generally before t=0 due to the previous implementation of the cycle). In said time interval, all the switches of the current port 20 are in the on state, which implies that v₁=0.

Thereby, using the relation R1, one obtains:

$${v}_{x} = {L}_{b} \cdot {v}_{2}^{′} + {L}_{c} \cdot {v}_{3}^{′}$$

At the voltage ports, the switches T₂₂, T₂₄, T₃₂ and T₃₄ should be in the on state, so that:

$${v}_{2}^{′} = - {V}_{2} \cdot \frac{{n}_{1}}{{n}_{2}} , {v}_{3}^{′} = - {V}_{3} . \frac{{n}_{1}}{{n}_{3}} and {v}_{x} < 0$$

As a result, the current i_{L1} increase from −I₁ to I₁ in the interval. Neglecting the resistance R₁ in series with the leakage inductance at the port 1, the current i_{L1} is expressed according to the following relationship R2:

$${i}_{L 1} ( t ) = - \frac{{v}_{x}}{{L}_{1}} t - {I}_{1} = \frac{{L}_{b} \cdot {V}_{2} \cdot \frac{{n}_{1}}{{n}_{2}} + {L}_{c} \cdot {V}_{3} \cdot \frac{{n}_{1}}{{n}_{3}}}{{L}_{1}} t - {I}_{1}$$

Where:
I₁ is the input current value i₁ of the current port 20 at the selected operating point.

The current is considered constant at each operating point since same is limited by the inductance L_{f}, which is a value much larger than the inductance value L₁.

When i_{L1} approaches the value I₁, the current begins to flow more through the diodes D₁ and D₄ and less through the diodes D2 and D₃.

At t=t₀, the diodes D₂ and D₃ switch into the off state.

The second time interval gathers instants t such as

$${t}_{0} \leq t \leq \frac{{T}_{s}}{2} .$$

During said time interval, the input current I₁ flows through T₁, T₄, D₁ and D₄ and i_{L1}=I₁. The switches T₂ and T₃ go into the off state between t₀ and t₁ at zero current (also designated by the acronym ZCS referring to “Zero Current Switching”). The switching of the voltage bridges 22 and 24 is then used so as to ensure that the current i_{L1} of the transformer 26 switches over in the next time interval.

At t=t₁, the H-bridge 38 of the voltage port 2 switches over and

$${v}_{2}^{′} = {V}_{2} \cdot \frac{{n}_{1}}{{n}_{2}} .$$

At t=t₂, the H-bridge 40 of the voltage port 3 switches over and

$${v}_{3}^{′} = {V}_{3} \cdot \frac{{n}_{1}}{{n}_{3}} .$$

Ideally, the above does not affect the value of the current i_{L1} since same is imposed by the current source 26 (L_{f}>>L₁).

In the present model, the ideal case is considered. As a result, the approximation is made that the current i_{L1} is perfectly trapezoidal and that the resistance R₁ is negligible, which leads to the following expression for the AC voltage at the port 1:

$${v}_{1} = {v}_{x} = \frac{{L}_{b} \cdot {v}_{2}^{′} + {L}_{c} \cdot {v}_{3}^{′}}{( 1 - {L}_{a} )} > 0$$

The third time interval gathers the instants t such as

$$\frac{{T}_{s}}{2} \leq t \leq {t}_{3} .$$

At the instant

$$t = \frac{{T}_{s}}{2} ,$$

the switches T₂ and T₃ are set in the on state at zero current. As a result, all the switches of the current port 20 are again in the on state and the voltage v₁=0. The voltage at the star point becomes vₓ=L_{b}·v₂′+L_{c}·v₃′>0, with

$${v}_{2}^{′} = {V}_{2} . \frac{{n}_{1}}{{n}_{2}} et {v}_{3}^{′} = {V}_{3} \cdot \frac{{n}_{1}}{{n}_{3}} .$$

The current i_{L1} decreases from I₁ to −I₁ and satisfies the following relationship R3:

$${i}_{L 1} ( t ) = \frac{- {v}_{x}}{{L}_{1}} ( t - \frac{{T}_{s}}{2} ) + {I}_{1} = - \frac{( {L}_{b} \cdot {V}_{2} \cdot \frac{{n}_{1}}{{n}_{2}} + {L}_{c} \cdot {V}_{3} \cdot \frac{{n}_{1}}{{n}_{3}} )}{{L}_{1}} ( t - \frac{{T}_{s}}{2} ) + {I}_{1}$$

At the instant t=t₃, the diodes D₁ and D₄ are in the off state.

The fourth time interval gathers instants t such as t₃≤t≤Tₛ.

The input current flows entirely through T₂, T₃, D₂ and D₃ in said time interval and i_{L1}=−I₁.

At the instant t=t₄, the switches T₁ and T₄ are set in the on state at zero current.

At the instants t=t₅ and t=t₆, the voltage ports 2 and 3 are respectively switched and

$${v}_{2}^{′} = - {V}_{2} . \frac{{n}_{1}}{{n}_{2}} and {v}_{3}^{′} = - {V}_{3} . \frac{{n}_{1}}{{n}_{3}} .$$

The AC voltage at the port 1 is written as:

$${v}_{1} = {v}_{x} = \frac{{L}_{b} \cdot {v}_{2}^{′} + {L}_{c} \cdot {v}_{3}^{′}}{( 1 - {L}_{a} )} < 0$$

The cycle is then repeated for each switching period Tₛ.

### 1.3—Operating Conditions

In order for power transfer between ports to occur with smooth switching across the entire operating range for all bridges, while preventing surges at the port 1, there are three main conditions to check.

To avoid surges and have smooth switching at the port 1, switches should not be in the off state until the transformer current is completely reversed i_{L1} and the series diodes are off. Otherwise, the switches would block a large part of the current in the inductive part, which would cause a sudden surge at the port 1.

Such a condition can thus be written as follows:

$${t}_{4} \geq {t}_{3} \to {D}_{1} {T}_{s} \geq \frac{{T}_{s}}{2} + {t}_{0}$$

Where

$${t}_{0} = \frac{2 {L}_{1} {I}_{1}}{( {L}_{b} \cdot {V}_{2} \cdot \frac{{n}_{1}}{{n}_{2}} + {L}_{C} \cdot {V}_{3} \cdot \frac{{n}_{1}}{{n}_{3}} )}$$

with reference to the relation R2.

A relation R4 results therefrom:

$${D}_{1} \geq \frac{2 {L}_{1} {I}_{1}}{( {L}_{b} \cdot {V}_{2} \cdot \frac{{n}_{1}}{{n}_{2}} + {L}_{c} \cdot {V}_{3} \cdot \frac{{n}_{1}}{{n}_{3}} ) \cdot {T}_{s}} + \frac{1}{2}$$

The AC voltages at the voltage ports v₂′ and v₃′ should be reversed after the current is completely reversed i_{L1} and the diodes and associated switches for port 1 are off.

If v₂ and/or v₃ are reversed before, one might to be able to reverse the current i_{L1}, so that no power can be exchanged between the ports. In addition, if the voltages v₂ and/or v₃ are reversed between the blocking of the diodes and the associated switch, the diodes will be able to switch back to the on state, thereby causing surges at the port 1. Such condition also ensures a smooth switching on the voltage ports and the associated conditions can be written:

$${t}_{5} \geq {t}_{4} \to \frac{{D}_{1} {T}_{s}}{2} + {φ}_{2} \frac{{T}_{s}}{2 π} + \frac{{T}_{s}}{4} \geq {D}_{1} {T}_{s}$$

$$and$$

$${t}_{6} \geq {t}_{4} \to \frac{{D}_{1} {T}_{s}}{2} + {φ}_{3} \frac{{T}_{s}}{2 π} + \frac{{T}_{s}}{4} \geq {D}_{1} {T}_{s}$$

The two conditions corresponding to the following relations R5 and R6 result therefrom:

$${φ}_{2} \geq π . ( {D}_{1} - \frac{1}{2} )$$

$$and$$

$${φ}_{3} \geq π . ( {D}_{1} - \frac{1}{2} )$$

It can be deduced from the relations R2 and R3 that the slope of the current i_{L1} during the reversal thereof is proportional to −vₓ=−(L_{b}·v₂′+L_{c}·v₃′).

Thereby, the reversal of the current is guaranteed if both the AC voltages of the ports 2 and 3 have the same sign (both negative for a positive slope and positive for a negative slope).

In addition, the slope of the current i_{L1} will be maximized in this way. Thereby, conditions R5 and R6 will always simultaneously satisfied.

It is thereby apparent that said conditions depend on the operating point of the converter 10, due to the fact that I₁, V₃, D₁, φ₂ and φ₃ vary according to the desired power, making complex the control of such topology.

### 1.4—Generalized Average Model of the Converter 10

The equations of state of the system studied are the system corresponding to the following relation R7:

$$\{ \begin{matrix}{L}_{f} \frac{d {i}_{1}}{d t} = {V}_{1} - {V}_{d c , 1} - {R}_{f} . {i}_{1} \\ {C}_{3} \frac{d {V}_{3}}{d t} = - \frac{{V}_{3}}{{R}_{L 3}} + {S}_{3} . {i}_{13} . \frac{{n}_{1}}{{n}_{3}} + {S}_{3} . {i}_{23} . \frac{{n}_{1}}{{n}_{3}} \\ {L}_{12} \frac{d {i}_{12}}{d t} = {v}_{1} - \frac{{n}_{1}}{{n}_{2}} {S}_{2} . {V}_{2} - {R}_{12} . {i}_{12} \\ {L}_{13} \frac{d {i}_{13}}{d t} = {v}_{1} - \frac{{n}_{1}}{{n}_{3}} {S}_{3} . {V}_{3} - {R}_{13} . {i}_{13} \\ {L}_{23} \frac{d {i}_{23}}{d t} = \frac{{n}_{1}}{{n}_{2}} {S}_{2} . {V}_{2} - \frac{{n}_{1}}{{n}_{3}} {S}_{3} . {V}_{3} - {R}_{23} . {i}_{23}\end{matrix}$$

Where:

$${V}_{dc , 1} = \{ \begin{matrix}{v}_{1} & for 0 \leq t \leq \frac{{T}_{s}}{2} \\ - {v}_{1} & for \frac{{T}_{s}}{2} \leq t \leq {T}_{s}\end{matrix} ,$$

$${S}_{2} ( t ) = \{ \begin{matrix}1 & for {t}_{1} \leq t < {t}_{5} \\ - 1 for & 0 \leq t < {t}_{1} and {t}_{5} \leq t < {T}_{s}\end{matrix} ,$$

$$and$$

$${S}_{3} ( t ) = \{ \begin{matrix}1 & for {t}_{2} \leq t < {t}_{6} \\ - 1 for & 0 \leq t < {t}_{2} and {t}_{6} \leq t < {T}_{s}\end{matrix} .$$

The average model usually used for power electronic circuits takes into account the average values of state variables to transform the discrete model into a continuous model. Such averaging model cannot be implemented for a converter 10, as same leads to a zero transformer current (since an AC variable is involved).

Therefore, the generalized average model of the system is developed to be studied as a continuous model while representing AC signals with better accuracy than the classical average model.

Thereby, DC signals are represented by average values (coefficient of order 0 of Fourier series) and AC signals are represented by the fundamental values (coefficient of order 1 of Fourier series) thereof.

The k-th coefficient of the Fourier series of a variable x is denoted by [symbol] x [symbol] ₖ and is complex and satisfies the following relation R8:

$${〈 x 〉}_{k} = {〈 x 〉}_{k R} + j {〈 x 〉}_{kI}$$

The large signal model of the system can thereby be derived from the relation 7 to obtain the system corresponding to the following relation R9:

$$\{ \begin{matrix}\frac{d {〈 {i}_{1} 〉}_{0}}{dt} = \frac{{V}_{1}}{{L}_{f}} - \frac{{〈 {V}_{dc , 1} 〉}_{0}}{{L}_{f}} - \frac{{R}_{f}}{{L}_{f}} \cdot {〈 {i}_{1} 〉}_{0} \\ \frac{d {〈 {V}_{3} 〉}_{0}}{dt} = - \frac{{〈 {V}_{3} 〉}_{0}}{{C}_{3} {R}_{L 3}} + \frac{2}{{C}_{3}} \cdot \frac{{n}_{1}}{{n}_{3}} \cdot {〈 {S}_{3} 〉}_{1 R} \cdot {〈 {i}_{13} 〉}_{1 R} + \frac{2}{{C}_{3}} \cdot \frac{{n}_{1}}{{n}_{3}} \cdot {〈 {S}_{3} 〉}_{1 I} \cdot {〈 {i}_{13} 〉}_{1 I} + \frac{2}{{C}_{3}} \cdot \frac{{n}_{1}}{{n}_{3}} \cdot {〈 {S}_{3} 〉}_{1 R} \cdot {〈 {i}_{23} 〉}_{1 R} + \frac{2}{{C}_{3}} \cdot \frac{{n}_{1}}{{n}_{3}} \cdot {〈 {S}_{3} 〉}_{1 I} \cdot {〈 {i}_{23} 〉}_{1 I} \\ \frac{d {〈 {i}_{12} 〉}_{1 R}}{dt} = \frac{{R}_{12}}{{L}_{12}} \cdot {〈 {i}_{12} 〉}_{1 R} + {ω}_{s} \cdot {〈 {i}_{12} 〉}_{1 I} + \frac{{〈 {v}_{1} 〉}_{1 R}}{{L}_{12}} - \frac{{n}_{1}}{{n}_{2}} \frac{{〈 {S}_{2} 〉}_{1 R}}{{L}_{12}} \cdot {V}_{2} \\ \begin{matrix}\frac{d {〈 {i}_{12} 〉}_{1 I}}{dt} = - {ω}_{s} \cdot {〈 {i}_{12} 〉}_{1 R} - \frac{{R}_{12}}{{L}_{12}} \cdot {〈 {i}_{12} 〉}_{1 I} + \frac{{〈 {v}_{1} 〉}_{1 I}}{{L}_{12}} - \frac{{n}_{1}}{{n}_{2}} \frac{{〈 {S}_{2} 〉}_{1 I}}{{L}_{12}} \cdot {V}_{2} \\ \frac{d {〈 {i}_{13} 〉}_{1 R}}{dt} = \frac{{R}_{13}}{{L}_{13}} \cdot {〈 {i}_{13} 〉}_{1 R} + {ω}_{s} \cdot {〈 {i}_{13} 〉}_{1 I} + \frac{{〈 {v}_{1} 〉}_{1 R}}{{L}_{13}} - \frac{{n}_{1}}{{n}_{3}} \frac{{〈 {S}_{3} 〉}_{1 R}}{{L}_{13}} \cdot {〈 {V}_{3} 〉}_{0} \\ \frac{d {〈 {i}_{13} 〉}_{1 I}}{dt} = - {ω}_{s} \cdot {〈 {i}_{13} 〉}_{1 R} - \frac{{R}_{13}}{{L}_{13}} \cdot {〈 {i}_{13} 〉}_{1 I} + \frac{{〈 {v}_{1} 〉}_{1 I}}{{L}_{13}} - \frac{{n}_{1}}{{n}_{3}} \frac{{〈 {S}_{3} 〉}_{1 I}}{{L}_{13}} \cdot {〈 {V}_{3} 〉}_{0} \\ \frac{d {〈 {i}_{23} 〉}_{1 R}}{dt} = - \frac{{R}_{23}}{{L}_{23}} \cdot {〈 {i}_{23} 〉}_{1 R} + {ω}_{s} \cdot {〈 {i}_{23} 〉}_{1 I} + \frac{{n}_{1}}{{n}_{2}} \frac{{〈 {S}_{2} 〉}_{1 R}}{{L}_{23}} \cdot {V}_{2} - \frac{{n}_{1}}{{n}_{3}} \frac{{〈 {S}_{3} 〉}_{1 R}}{{L}_{23}} \cdot {〈 {V}_{3} 〉}_{0} \\ \frac{d {〈 {i}_{23} 〉}_{1 I}}{dt} = - {ω}_{s} \cdot {〈 {i}_{23} 〉}_{1 R} - \frac{{R}_{23}}{{L}_{23}} \cdot {〈 {i}_{23} 〉}_{1 I} + \frac{{n}_{1}}{{n}_{2}} \frac{{〈 {S}_{2} 〉}_{1 I}}{{L}_{23}} \cdot {V}_{2} - \frac{{n}_{1}}{{n}_{3}} \frac{{〈 {S}_{3} 〉}_{1 I}}{{L}_{23}} \cdot {〈 {V}_{3} 〉}_{0}\end{matrix}\end{matrix}$$

Where:
the index R is the real part of a complex number,
the index I is the imaginary part of a complex number,

$${〈 {S}_{2} 〉}_{0} = {〈 {S}_{3} 〉}_{0} = 0 , {〈 {S}_{2} 〉}_{1 R} = \frac{2}{π} cos ( {D}_{1} π + {φ}_{2} ) , {〈 {S}_{2} 〉}_{1 I} = - \frac{2}{π} sin ( {D}_{1} π + {φ}_{2} ) , {〈 {S}_{3} 〉}_{1 R} = \frac{2}{π} cos ( {D}_{1} π + {φ}_{3} ) , {〈 {S}_{3} 〉}_{1 I} = - \frac{2}{π} sin ( {D}_{1} π + {φ}_{3} ) ,$$

$${〈 {v}_{1} 〉}_{1 R} = \frac{1}{π} . ( \frac{2 {L}_{b}}{( 1 - {L}_{a} )} . \frac{{n}_{1}}{{n}_{2}} . {V}_{2} . cos ( {D}_{1} π + {φ}_{2} ) + \frac{2 {L}_{C}}{( 1 - {L}_{a} )} . \frac{{n}_{1}}{{n}_{3}} . {〈 {V}_{3} 〉}_{0} . cos ( {D}_{1} π + {φ}_{3} ) +$$

$$( {L}_{b} . {V}_{2} . \frac{{n}_{1}}{{n}_{2}} + {L}_{c} . {〈 {V}_{3} 〉}_{0} . \frac{{n}_{1}}{{n}_{3}} ) . \frac{sin ( {ω}_{s} {t}_{0} )}{( 1 - {L}_{a} )} ) ,$$

$${〈 {v}_{1} 〉}_{1 R} = \frac{1}{π} . ( \frac{2 {L}_{b}}{( 1 - {L}_{a} )} . \frac{{n}_{1}}{{n}_{2}} . {V}_{2} . cos ( {D}_{1} π + {φ}_{2} ) + \frac{2 {L}_{C}}{( 1 - {L}_{a} )} . \frac{{n}_{1}}{{n}_{3}} . {〈 {V}_{3} 〉}_{0} . cos ( {D}_{1} π + {φ}_{3} ) +$$

$$( {L}_{b} . {V}_{2} . \frac{{n}_{1}}{{n}_{2}} + {L}_{c} . {〈 {V}_{3} 〉}_{0} . \frac{{n}_{1}}{{n}_{3}} ) . \frac{sin ( {ω}_{s} {t}_{0} )}{( 1 - {L}_{a} )} ,$$

$${〈 {v}_{1} 〉}_{1 I} = \frac{1}{π} . ( \frac{- 2 {L}_{b}}{( 1 - {L}_{a} )} . \frac{{n}_{1}}{{n}_{2}} . {V}_{2} . sin ( {D}_{1} π + {φ}_{2} ) - \frac{2 {L}_{C}}{( 1 - {L}_{a} )} . \frac{{n}_{1}}{{n}_{3}} . {〈 {V}_{3} 〉}_{0} . sin ( {D}_{1} π + {φ}_{3} ) +$$

$$( {L}_{b} . {V}_{2} . \frac{{n}_{1}}{{n}_{2}} + {L}_{c} . {〈 {V}_{3} 〉}_{0} . \frac{{n}_{1}}{{n}_{3}} ) . \frac{cos ( {ω}_{s} {t}_{0} )}{( 1 - {L}_{a} )} - ( {L}_{b} . {V}_{2} . \frac{{n}_{1}}{{n}_{2}} + {L}_{c} . {〈 {V}_{3} 〉}_{0} . \frac{{n}_{1}}{{n}_{3}} ) . \frac{1}{( 1 - {L}_{a} )} ) ,$$

$$and$$

$${〈 {V}_{d c , 1} 〉}_{0} = - 2 . ( {L}_{b} . {V}_{2} . \frac{{n}_{1}}{{n}_{2}} + {L}_{c} . {〈 {V}_{3} 〉}_{0} . \frac{{n}_{1}}{{n}_{3}} ) . \frac{{D}_{1}}{( 1 - {L}_{a} )} + 2 . ( {L}_{b} . {V}_{2} . \frac{{n}_{1}}{{n}_{2}} +$$

$${L}_{c} . {〈 {V}_{3} 〉}_{0} . \frac{{n}_{1}}{{n}_{3}} ) . \frac{1}{( 1 - {L}_{a} )} - \frac{2 {L}_{b}}{( 1 - {L}_{a} )} . \frac{{n}_{1}}{{n}_{2}} . {V}_{2} . \frac{{φ}_{2}}{π} - \frac{2 {L}_{C}}{( 1 - {L}_{a} )} . \frac{{n}_{1}}{{n}_{3}} . {〈 {V}_{3} 〉}_{0} . \frac{{φ}_{3}}{π} + \frac{4 {L}_{1}}{( 1 - {L}_{a} ) {T}_{s}} . {〈 {i}_{1} 〉}_{0} .$$

The large signal model can be represented in matrix form with:

$$\dot{X} = A . X + B . U$$

where:
X=[ [symbol] i₁ [symbol] ₀ [symbol] V₃ [symbol] ₀ [symbol] i₁₂ [symbol] _{1R} [symbol] i₁₂ [symbol] _{1I} [symbol] i₁₃ [symbol] _{1R} [symbol] i₁₃ [symbol] _{1I} [symbol] i₂₃ [symbol] _{1R} [symbol] i₂₃ [symbol] _{1I}]^{T}, and
U=[V₁ V₂]^{T}.

The input parameters of the control of the system are the duty cycle D₁ and the phase shifts φ₂ et φ₃.

The output parameters of the control of the system are [symbol] i₁ [symbol] ₀ and [symbol] V₃ [symbol] ₀.

As a result, the average equations obtained are nonlinear.

Linearization is to be performed at the operating point in order to be able to use conventional linear controllers.

The small signal model of the system is obtained by inserting small perturbations in the variables of the system at the operating point and by using a development in Taylor series, so that:

$$〈 x 〉 = {x}_{e q} +$$

Where:
the variables surmounted by the symbol “\hat{ }” represent the associated small signals (perturbations around the operating point), and
x_{eq} refers to the value of [symbol] x [symbol] at the operating point, which is sometimes also called the equilibrium point.

The perturbations of voltage sources around the mean values can be neglected in the present study ( [symbol] = [symbol] =0).

The above is mainly due to the slow variation thereof compared to the fast dynamics of the control (e.g. the voltage of the photovoltaic panel, the battery system or the power grid). The resulting linearized mathematical model has an order of 8.

### 1.5—Reduced Order Model of the Converter 10

The reduced order model of a system is a simplified model that can be more easily used and used in simulations. Furthermore, the design of the system controllers thereby becomes much simpler.

As a result, it will be possible to recalculate the system controllers in real time when a change in the operating point occurs. However, the main drawback of order reduction is a lower precision for the mathematical model.

Average modeling at reduced order relies on the separation of system dynamics in the frequency domain into two parts: low-frequency dynamics (slow variables) and high-frequency dynamics (fast variables).

After the separation, only the dominant dynamics of the system are taken into account for the study of the behavior of the system.

For the converter 10, the DC variables can be considered as slow variables and the AC variables as fast variables. In such case, the slow variables represent the input and output parameters of the system, whereas the fast variables represent the internal operation of the converter 10.

Since the purpose of controlling the converter 10 is to regulate the input and output parameters, the dominant low frequency dynamics are retained, and the fast dynamics are ignored in the reduced order model.

The two subsystems can thereby be represented as follows, separating the state vector X of the non-reduced system into two parts:

X=[XₛX_{f}]^{T}

where:
the index ‘s’ means the slow dynamic subsystem,
index ‘f’ means the fast dynamic subsystem,
Xₛ=[ [symbol] i₁ [symbol] ₀ [symbol] V₃ [symbol] ₀]^{T}, and
X_{f}=[ [symbol] i₁₂ [symbol] _{1R} [symbol] i₁₂ [symbol] _{1I} [symbol] i₁₃ [symbol] _{1R} [symbol] i₁₃ [symbol] _{1I} [symbol] i₂₃ [symbol] _{1R} [symbol] i₂₃ [symbol] _{1I}]^{T}

Thereby, the system of relation R9 becomes:

$$\dot{X} = A . X + B . U \to \{ \begin{matrix}{\dot{X}}_{s} = {A}_{s s} . {X}_{s} + {A}_{s f} . {X}_{f} + {B}_{s} . U \\ {\dot{X}}_{f} = {A}_{f s} . {X}_{s} + {A}_{f f} . {X}_{f} + {B}_{f} . U\end{matrix}$$

where:
The matrices Aₛₛ, A_{sf}, A_{fs}, and A_{ff} are parts of matrix A designated before, Aₛₛ being the gain matrix between the variables \dot{X}ₛ and Xₛ, A_{sf} the gain matrix between the variables \dot{X}ₛ and X_{f}, A_{fs} the gain matrix between the variables \dot{X}_{f} and Xₛ and A_{ff} the gain matrix between variables \dot{X}_{f} and X_{f}
Bₛ and B_{f} are parts of the matrix B linking \dot{X}ₛ and \dot{X}_{f} to the matrix of the inputs U.

The matrices Aₛₛ, A_{sf}, A_{fs}, A_{ff}, Bₛ and B_{f} are obtained by rearranging the matrices A and B.

To obtain the reduced order model, the fast dynamic subsystem is first solved at a chosen operating point (equilibrium point) (\dot{X}_{f,eq}=0), assuming that the slow variables are constant and equal to the average values thereof, i.e.:

Xₛ=X_{s,eq}, so that [symbol] i₁ [symbol] ₀=I_{1,eq} and [symbol] V₃ [symbol] ₀=V_{3,eq}

The average response X_{f,eq} of the fast dynamic subsystem is thereby obtained.

Then, for the slow dynamic subsystem, the fast variables are replaced by the average response calculated previously. X_{f}=X_{f,eq} is thereby obtained.

The slow dynamic subsystem is then linearized around the selected operating point while ignoring the dynamics of the fast variables. The above gives a linearized reduced order model of the converter 10, the expression of which is given by a relation R10 corresponding to the following two equation system:

$$\{ \begin{matrix}\frac{d {〈 {\hat{l}}_{1} 〉}_{0}}{d t} = ( - \frac{{R}_{f}}{{L}_{f}} - \frac{4 {L}_{1}}{{L}_{f} . ( 1 - {L}_{a} ) . {T}_{s}} ) . {〈 {\hat{l}}_{1} 〉}_{0} + \frac{2 {L}_{c}}{{L}_{f} . ( 1 - {L}_{a} )} . \frac{{n}_{1}}{{n}_{3}} ( {D}_{1 , eq} - 1 + \frac{{φ}_{3 , eq}}{π} ) . {〈 {\hat{V}}_{3} 〉}_{0} ++ ( \frac{2 {L}_{b}}{{L}_{f} . ( 1 - {L}_{a} )} . \frac{{n}_{1}}{{n}_{2}} . {V}_{2} + \frac{2 {L}_{c}}{{L}_{f} . ( 1 - {L}_{a} )} . \frac{{n}_{1}}{{n}_{3}} . {V}_{3 , eq} ) . {\hat{D}}_{1} + \frac{2 {L}_{b}}{{L}_{f} . ( 1 - {L}_{a} )} . \frac{{n}_{1}}{{n}_{2}} . {V}_{2} . \frac{{\hat{φ}}_{2}}{π} + \frac{2 {L}_{c}}{{L}_{f} . ( 1 - {L}_{a} )} . \frac{{n}_{1}}{{n}_{3}} . {V}_{3 , eq} \cdot \frac{{\hat{φ}}_{3}}{π} \\ \frac{d {〈 {\hat{V}}_{3} 〉}_{0}}{d t} = - \frac{{〈 {\hat{V}}_{3} 〉}_{0}}{{C}_{3} {R}_{L 3}} - \frac{4}{{C}_{3}} \cdot \frac{{n}_{1}}{{n}_{3}} \cdot [ {I}_{13 , R , eq} \cdot sin ( {D}_{1 , eq} \cdot π + {φ}_{3 , eq} ) + {I}_{13 , I , eq} \cdot cos ( {D}_{1 , eq} \cdot π + {φ}_{3 , eq} ) + {I}_{23 , R , eq} \cdot sin ( {D}_{1 , eq} \cdot π + {φ}_{3 , eq} ) + {I}_{23 , I , eq} \cdot cos ( {D}_{1 , eq} \cdot π + {φ}_{3 , eq} ) ] \\ \cdot cos ( {D}_{1 , eq} \cdot π + {φ}_{3 , eq} ) ] \cdot {\hat{D}}_{1} - \frac{4}{π {C}_{3}} \cdot \frac{{n}_{1}}{{n}_{3}} \cdot [ {I}_{13 , R , eq} \cdot sin ( {D}_{1 , eq} \cdot π + {φ}_{3 , eq} ) + {I}_{13 , I , eq} \cdot cos ( {D}_{1 , eq} \cdot π + {φ}_{3 , eq} ) + {I}_{23 , R , eq} \cdot sin ( {D}_{1 , eq} \cdot π + {φ}_{3 , eq} ) ++ {I}_{23 , I , eq} \cdot cos ( {D}_{1 , eq} \cdot π + {φ}_{3 , eq} ) ] \cdot {\hat{φ}}_{3} \\\end{matrix}$$

It thereby appears that the order of the mathematical model was reduced from 8 to 2 using the reduced order modeling technique. It is in this way easier to analyze the dynamic behavior and the design of the control of the converter 10.

The application of the Laplace transform to the model of the relation R10 leads to a reduced transfer function linking the input current I₁ of the port 1 to the duty cycle D₁ by a first transfer function Gᵢ₁_{ᵣ} and the output DC voltage V₃ of the port 3 to the phase shift φ₃ by a second transfer function Gᵥ₃_{ᵣ}(s).

The first transfer function is expressed Gᵢ₁_{ᵣ} according to the following relation R11:

$${G}_{i {1}_{r}} ( s ) = \frac{{I}_{1} ( s )}{{D}_{1} ( s )} {\vert}_{{{\hat{φ}}_{2} = 0}_{{\hat{φ}}_{3} = 0}} = \frac{a . s + b}{( s + c ) ( s + d )}$$

Where:

$$a = \frac{2 {L}_{b}}{{L}_{f} . ( 1 - {L}_{a} )} . \frac{{n}_{1}}{{n}_{2}} . {V}_{2} + \frac{2 {L}_{C}}{{L}_{f} . ( 1 - {L}_{a} )} . \frac{{n}_{1}}{{n}_{3}} . {V}_{3 , eq} ,$$

$$b = \frac{a}{{C}_{3} {R}_{L 3}} - \frac{8}{{C}_{3}} . \frac{{L}_{c}}{{L}_{f} . ( 1 - {L}_{a} )} . {( \frac{{n}_{1}}{{n}_{3}} )}^{2} ( {D}_{1 , eq} - 1 + \frac{{φ}_{3 , eq}}{π} ) \cdot ( {I}_{13 , R , eq} . sin ( {D}_{1 , eq} \cdot π + {φ}_{3 , eq} ) \\ + {I}_{13 , I , eq} . cos ( {D}_{1 , eq} \cdot π + {φ}_{3 , eq} ) + {I}_{23 , R , eq} . sin ( {D}_{1 , eq} \cdot π + {φ}_{3 , eq} ) \\ + {I}_{23 , I , eq} . cos ( {D}_{1 , eq} \cdot π + {φ}_{3 , eq} ) ) , and$$

$$c = \frac{{R}_{f}}{{L}_{f}} + \frac{4 {L}_{1}}{{L}_{f} \cdot ( 1 - {L}_{α} ) \cdot {T}_{s}} .$$

The expression of the first transfer function Gᵢ₁_{ᵣ} can be further simplified by ignoring the voltage V₃ dynamics, i.e. considering that the value V₃ does not vary much around the nominal value thereof. A first reduced transfer function of order 1 corresponding to the following relation R12 is thereby obtained:

$${G}_{i {1}_{r 2}} ( s ) = \frac{{I}_{1} ( s )}{{D}_{1} ( s )} {\vert}_{{{{\hat{φ}}_{2} = 0}_{{\hat{φ}}_{3} = 0}}_{{\hat{V}}_{3} = 0}} \frac{a}{( s + c )}$$

The second transfer function is expressed Gᵥ₃_{ᵣ} according to the following relation R13:

$${G}_{v {3}_{r}} ( s ) = \frac{{V}_{3} ( s )}{{φ}_{3} ( s )} {\vert}_{{{\hat{φ}}_{2} = 0}_{{\hat{D}}_{1} = 0}} \frac{e}{( s + d )}$$

Where:

$$d = \frac{1}{{C}_{3} {R}_{L 3}} ,$$

$$and e = \frac{4}{π {C}_{3}} \cdot \frac{{n}_{1}}{{n}_{3}} \cdot ( {I}_{13 , R , e q} \cdot sin ( {D}_{1 , e q} \cdot π + {φ}_{3 , e q} ) + {I}_{13 , I , eq} \cdot cos ( {D}_{1 , eq} \cdot π + {φ}_{3 , e q} ) + {I}_{23 , R , e q} \cdot sin ( {D}_{1 , e q} \cdot π + {φ}_{3 , e q} ) + {I}_{23 , I , eq} \cdot cos ( {D}_{1 , e q} \cdot π + {φ}_{3 , e q} ) )$$

The order of the first and second reduced transfer functions Gᵥ₃_{ᵣ} and Gᵢ₁_{ᵣ₂} is independent of the number of ports of the converter 10.

Thereby, the reduced order model just described for a converter 10 with hybrid supply can be generalized to an n-port MAB converter 10, 1 port being a current supply port while the other (n−1) ports are voltage supply ports.

The first and second reduced transfer functions are then still of the first order independently of the number of ports of the MAB converter 10, so that the voltages of the voltage supply ports do not vary much around the average values at a certain operating point.

The reduced order models can be used for the analysis of the converter 10 and for designing closed loop controllers.

### 1.6—Control Strategy

There are two parameters to be controlled in the system (the output control parameters), namely the input DC current of the port 1 and the output DC voltage V₃ of the port 3.

However, there are three input control parameters: the duty cycle D₁ and the phase shifts φ₂ and φ₃.

Thereby, at a chosen operating point, there is an infinite combination of values for the input control parameters that can give the desired values satisfying the relations R4 to R6. The elements of such a combination will be named D_{1,eq}, φ_{2,eq} and φ_{3,eq} for the input control parameters and I_{1,eq} and V_{3,eq} for the output control parameters.

In addition, from the system R9, it can be noted that the output control parameters I_{1,eq} and V_{3,eq} depend on all the input control parameters, D_{1,eq}, φ_{2,eq} and φ_{3,eq}. The above shows that the converter 10 structure studied is coupled and that a change in one of the control variables has an effect on all ports.

One way of controlling a converter 10 is to make D_{1,eq} equal to a minimum permissible value D_{1,min} in the relation R4 with a safety margin ϵ at each operating point. One thereby has:

$${D}_{1 , eq} = {D}_{1 , min} + ϵ$$

The value of ϵ can be chosen arbitrarily, e.g. set at 0.01.

The corresponding values of φ_{2,eq} and φ_{3,eq} are then calculated from the system of the relation R9 at the selected operating point.

Then, using the relations R5 and R6, a minimum allowed value is obtained for φ₂ and φ₃.

The calculated values of the three input control parameters are then sent to the system.

Adding a feedback loop to the control of the converter 10 allows the ports to be decoupled.

Approximations made to develop the mathematical model will result in an error in the steady state if only the open control loop is applied.

A PI controller is therefore used for each of the control loops in order to eliminate such error (see FIGS. 3 and 4). The controllers are calculated on the basis of the reduced order model presented hereinabove. Adjustment subunits 70 and 90 are added to ensure that conditions R4 to R6 are always met.

In the case of FIGS. 3 and 4, the maximum permissible for the value of D₁ is denoted by D_{1,max} and is equal to 1.

Similarly, the maximum permissible for the values of φ₂ and of φ₃ is denoted by φₘₐₓ and calculated as follows:

$${t}_{5} \leq {T}_{s} and {t}_{6} \leq {T}_{s} \to {φ}_{max} = π \cdot ( \frac{3}{2} - {D}_{1} )$$

The transfer function of the conversion subunit 66 is thereby expressed as follows:

$${C}_{1} ( s ) = \frac{{K}_{p 1} \cdot ( {T}_{i 1} \cdot s + 1 )}{{T}_{i 1} \cdot s}$$

By using the first transfer function Gᵢ₁_{ᵣ₂} of the relation R12, a first order transfer function is obtained.

$${T}_{i 1} = \frac{1}{c}$$

is chosen.

The closed loop transfer function CLTF₁ becomes:

$$C L T {F}_{1} ( s ) = \frac{{C}_{1} ( s ) {G}_{i 1} ( s )}{1 + {C}_{1} ( s ) {G}_{i 1} ( s )} = \frac{{K}_{p 1} \cdot a}{s + {K}_{p 1} \cdot a} = \frac{1}{{τ}_{1} \cdot s + 1}$$

Where:

$${τ}_{1} = \frac{1}{{K}_{p 1} \cdot a}$$

is the time constant of the closed loop system.

And yet, the response time of the closed loop transfer function in order to obtain the 95% of the reference current is such that t_{r1.95%}=3·τ₁.

The gain Kₚ₁ is then chosen for the desired value of t_{r1.95%}, so that the gain satisfies:

$${K}_{p 1} = \frac{3}{a \cdot {t}_{r 1.95 \%}}$$

As for the transfer function of the conversion subunit 86, same is expressed as follows:

$${C}_{3} ( s ) = \frac{{K}_{p 3} \cdot ( {T}_{i 3} \cdot s + 1 )}{{T}_{i 3} \cdot s}$$

By using the second transfer function Gᵥ₃_{ᵣ} of the relation R13, a first order transfer function is obtained.

$${T}_{i 3} = \frac{1}{d}$$

is chosen.

The closed loop transfer function CLTF₃ becomes:

$${CLTF}_{3} ( s ) = \frac{{C}_{3} ( s ) {G}_{v 3} ( s )}{1 + {C}_{3} ( s ) {G}_{v 3} ( s )} = \frac{{K}_{p 3} \cdot e}{s + {K}_{p 3} \cdot e} = \frac{1}{{τ}_{3} \cdot s + 1}$$

Where:

$${τ}_{3} = \frac{1}{{K}_{p 3} \cdot e}$$

is the time constant of the closed loop system.

And yet, the response time of the closed loop transfer function in order to obtain the 95% of the reference voltage such that t_{r3.95%}=3·τ₃.

The gain Kₚ₃ is then chosen for the desired value of t_{r3.95%}, so that the gain satisfies:

$${K}_{p 3} = \frac{3}{e \cdot {t}_{r 3.95 \%}}$$

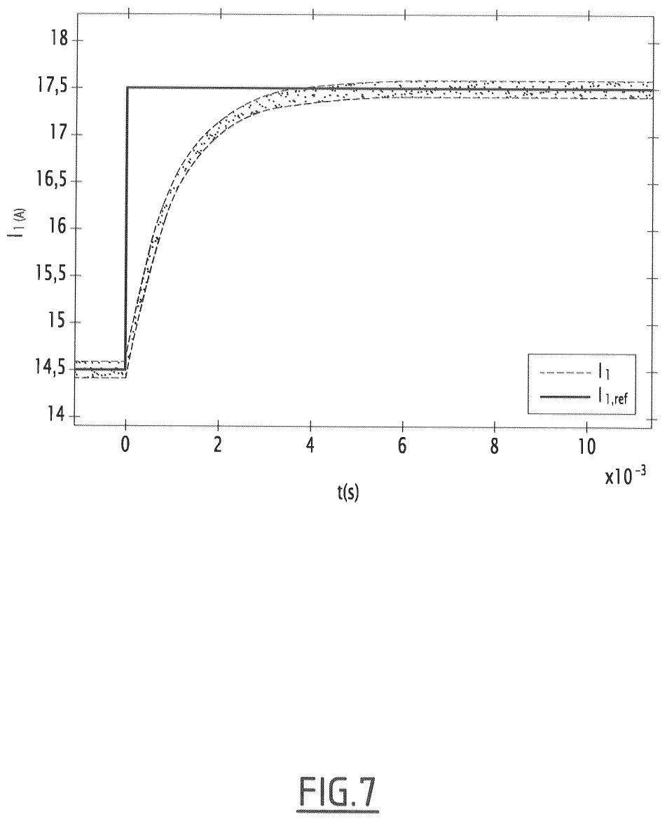

FIG. 7 shows the results of simulations of a closed-loop control of the current I₁.

The values of the parameters of the simulated converter 10 are given in Table 1 below.

TABLE 1

| Parameters | Value in the simulation | |
|---|---|---|
| V₁ | 200 | V |
| V₂ | 400 | V |
| fₛ | 20 | KHz |
| L_{f} | 0.016 | H |
| R_{f} | 10 | mΩ |
| L₁ | 83 | μH |
| R₁ | 10 | mΩ |
| L₂ | 83 | μH |
| R₂ | 10 | mΩ |
| L₃ | 230 | μH |
| R₃ | 10 | mΩ |
| C₃ | 100 | μH |
| R_{c3} | 1 | mΩ |
| Lₘ | 8.3 | mH |
| n₁ | 100 | turns |
| n₂ | 83 | turns |
| n₃ | 124 | turns |
| P_{3, nominal} | 3 kW | (received) |
| P_{1, nominal} | 3.5 kW | (delivered) |
| Pₘₐₓ (between two ports) | 4 | kW |
| R_{L3} | 120 | Ω |

The response time has been chosen so that the values of the parameters of the controller PI1 of the relations R14 are such that t_{r1.95%}=3 ms.

The observation of FIG. 7 shows that the response time of the open loop is indeed equal to the chosen value of 3 ms, which validates the development of the mathematical model of the controller.

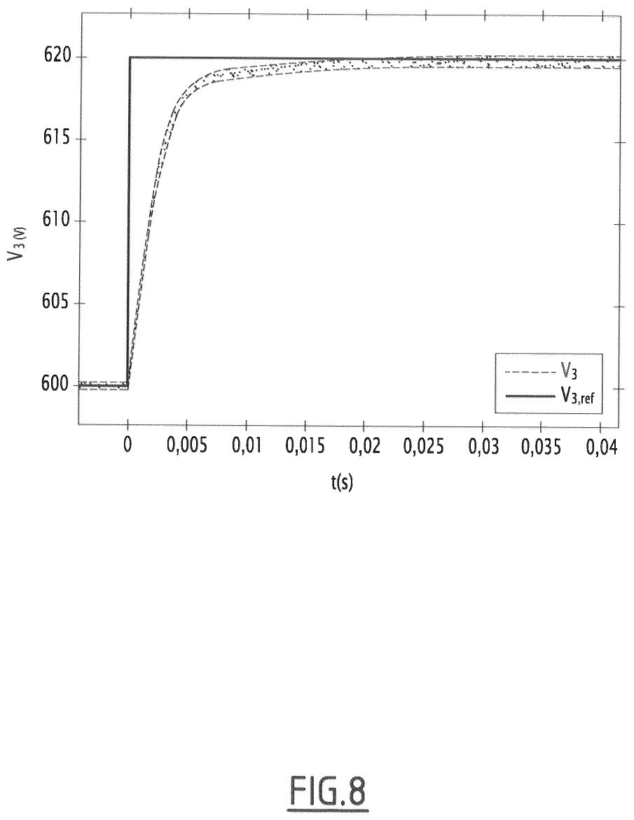

FIG. 8 shows the results of the same simulation for the closed loop control of the output voltage V₃.

The response time has been chosen so that the values of the parameters of the controller PI3 of the relations R15 are such that t_{r3.95%}=10 ms.

The observation of FIG. 8 shows that the response time of the open loop is indeed equal to the chosen value of 10 ms, which validates the development of the mathematical model of the controller.

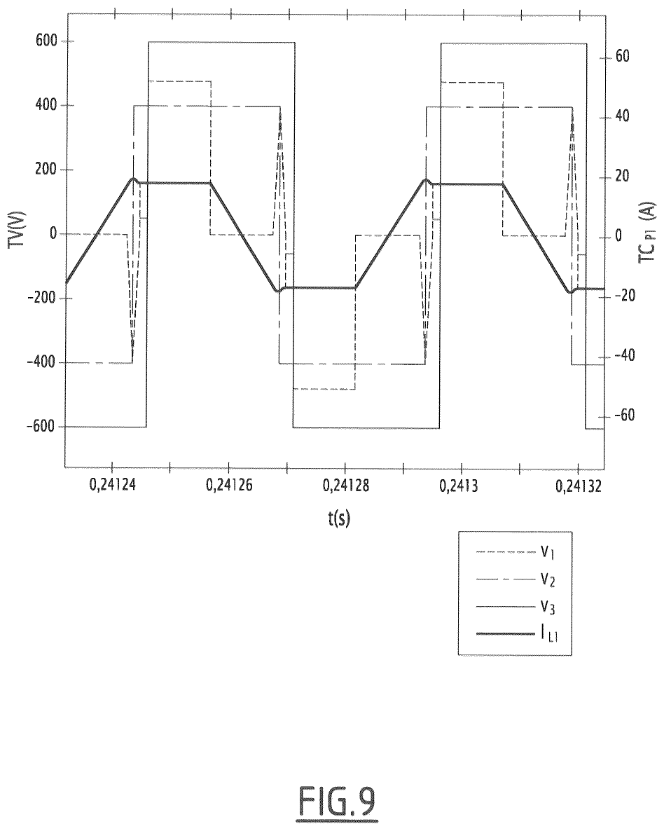

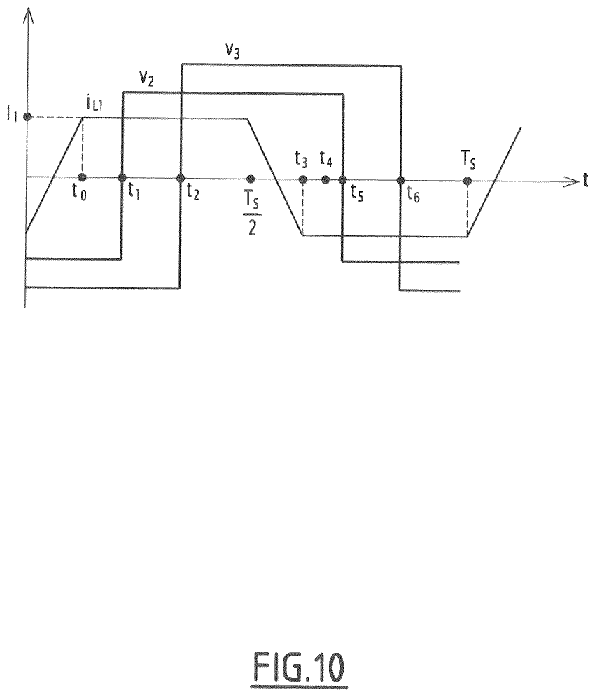

FIGS. 9 and 10 show the evolution of each of the voltage values v₁, v₂, v₃ and I_{L1} obtained by simulation and theoretical, respectively.

The comparison of the two figures clearly shows that the signals obtained by simulation are according to the theoretical forms.

The minimal discrepancy between the characteristics chosen for the calculation of the controller parameters and the characteristics of the simulated responses is due to simplification assumptions that have been made, in particular the first harmonic approximation of the AC signals and the model order reduction.

To improve the accuracy of the model, higher order harmonics could be considered. However, a complexity of the model would follow therefrom.

The model described serves to obtain the best compromise between precision and complexity.

### 2—Other Cases

In the structure of the converter 10, the coupling between the ports 20, 22 and 24 is generated by the presence of the inductances of the isolation interfaces 48, 50 and 52.

However, the absence of an inductance on one of the ports is a special case that can be regulated with the same regulation strategy.

In such a case, the conversion functions without order reduction would be written:

$${G}_{i {1}_{r}} ( s ) = \frac{\frac{2 \frac{{n}_{1}}{{n}_{2}} {V}_{2}}{{L}_{f}}}{s + ( \frac{{R}_{f}}{{L}_{f}} + \frac{4 {L}_{1}}{{L}_{f} {T}_{S}} )}$$

and:

$${G}_{v 3} ( s ) = \frac{\frac{4 b}{π {C}_{3}} ( s + \frac{{R}_{3}}{{L}_{3}} - \frac{a}{b} {w}_{s} )}{\begin{matrix}\begin{matrix}{s}^{3} + ( 2 \frac{{R}_{3}}{{L}_{3}} + \frac{1}{{R}_{L 3} {C}_{3}} ) {s}^{2} + \\ ( 2 {( \frac{{R}_{3}}{{L}_{3}} )}^{2} + {w}_{s}^{2} + 2 \frac{{R}_{3}}{{R}_{L 3} {C}_{3} {L}_{3}} + \frac{8}{{π}^{2} {C}_{3} {L}_{3}} ) s +\end{matrix} \\ ( \frac{8 {R}_{3}}{{π}^{2} {C}_{3} {L}_{3}} + \frac{{R}_{3}^{2}}{{R}_{L 3} {C}_{3} {L}_{3}^{2}} + \frac{{w}_{s}^{2}}{{R}_{L 3} {C}_{3}} )\end{matrix}}$$

$$a = \frac{2}{{L}_{3}} \frac{{n}_{3}}{{n}_{2}} {V}_{2} cos ( {φ}_{23} ) ,$$

$$b = - \frac{2}{{L}_{3}} \frac{{n}_{3}}{{n}_{2}} {V}_{2} sin ( {φ}_{23} ) ,$$

φ₂₃ being the phase shift between the voltages V₂ et V₃.

It can be noted herein that in such case, only the voltage port that has no inductance (called the master port) is subject to the control constraints imposed by the current port. Therefore, the external phase shift of the port has minimum and maximum permissible values. The external phase shifts of the other voltage ports can have any value calculated so as to obtain a desired value of the DC output voltage thereof.

In addition, the sources/loads connected to the ports can be changed. For example, the load 39 can be replaced by a voltage source and the port 3 can be made bi-directional.

Similarly, a load 39 can replace the voltage source of the port 2.

In each of such cases, at least one voltage port [is] connected to a stable voltage source, the average value of which does not vary too much over time.

An electrical grid or a battery are examples of such a stable voltage source.

Finally, the mathematical model and the control strategy proposed in the present patent can be generalized to a MAB converter consisting of a total of n ports, n being any integer and one port being supplied with current.

In such a case, the multi-active bridge converter 10 comprises the input current port 20 and at least one output voltage port.

Each output voltage port is associated with a control unit as per the control unit described with reference to FIG. 4, so that the regulation system 28 includes (n−1) control unit(s).

In each case, the proposed converter can be used in particular in domestic applications or in electric vehicles.

1. A regulation system for a multi-active bridge converter with hybrid supply, the multiple active bridge converter comprising:
an input current port comprising an H-shape switch bridge for which a reference switch is defined, the reference switch being called the first reference switch and being controlled by a first control law, the first control law having a first duty cycle,
at least one output voltage port comprising an H-shape switch bridge for which a reference switch is defined, the reference switch being called the second reference switch and being controlled by a respective second control law, each second control law having a second predefined duty cycle and a phase shift with respect to the first control law,
a transformer having windings, each winding being connected to a port by a respective isolation interface,
the regulation system being apt to regulate the active multi-bridge active to a setpoint, the setpoint comprising a setpoint current value for the current of the current port and at least one setpoint voltage value for the at least one voltage port, the regulation system comprising:
a measuring unit for measured values, the measured values comprising the current of the current port and the voltage of each voltage port,
a first control unit of the first reference switch, the first control unit comprising:
a first subunit for calculating a first desired initial value, the first desired initial value being a desired value for the first duty cycle equal to the sum of the result of a first calculation function applied to the set values and a safety margin,
a first subunit for determining the difference between the measured current value and the setpoint current value, in order to obtain a determined difference of current,
a first correction subunit apt to convert the determined difference of current into a first corrective value for the first duty cycle by applying a first conversion function,
a first addition subunit for adding the first desired initial value and the first corrective value, so as to obtain a first candidate value,
a first adjustment subunit suitable for adjusting the first candidate value so as to obtain a first value to be applied, comprised between two first extreme values, the first lowest extreme value being the result of the first calculation function applied to the measured values,
a first application subunit for applying the first control law having as duty cycle the first value to be applied, and
for each voltage port having a desired voltage value, a second control unit of the second reference switch of the voltage port (22, 24) considered, each second control unit comprising:
a second calculation subunit (82) of a second desired initial value (φ_{3,eq}), the second desired initial value (φ_{3,eq}) being a desired value for the phase shift (φ₂, φ₃) equal to the result of a second calculation function (FC2) applied to the first desired initial value (D_{1,eq}),
a second determination subunit for determining the difference between the measured voltage value for the voltage port considered and the setpoint voltage value for the voltage port considered, in order to obtain a determined difference of voltage,
a second correction subunit apt to convert the determined difference of voltage into a second corrective value for the phase shift by applying a second conversion function,
a second addition subunit for adding the second desired initial value and the second corrective value, so as to obtain a second candidate value,
a second adjustment subunit suitable for adjusting the second candidate value so as to obtain a second value to be applied between two second extreme values, the second lowest extreme value being the result of the second calculation function applied to the first desired initial value, and
a second application subunit for applying the second control law having as phase shift the second value to be applied.

2. The regulation system according to claim 1, wherein each adjustment subunit is apt to give as the value to be applied, the candidate value unchanged when the candidate value is comprised between the two extreme values and otherwise the extreme value closest to the candidate value.

3. The regulation system according to claim 1, wherein the second highest extreme value is the result of a third calculation function applied to the desired first initial value.

4. The regulation system according to claim 3, wherein at least one of the second calculation function and the third calculation function is an affine function.

5. The regulation system according to claim 1, wherein each correction subunit (66, 86) is a proportional integral corrector.

6. The regulation system according to claim 1, wherein each conversion function (Gᵢ₁_{ᵣ}, Gᵥ₃_{ᵣ}) is a first order function.

7. The regulation system according to claim 1, wherein each H-bridge has two midpoints each isolation interface including two lines connecting a respective midpoint with one end of the associated winding, one of the two lines including a resistor in series with an inductance.

8. The regulation system according to claim 7, wherein each winding has turns, the first conversion function having a gain dependent on the measured values for the voltages, on the second desired initial value, on the number of turns of each winding and on the inductances of the isolation interfaces.

9. The regulation system according to claim 7, wherein each winding has turns, the second conversion function having a gain dependent on the measured current value, on the desired first initial value, on the second desired initial value, on the number of turns of each winding and on the inductances of the isolation interfaces.

10. The regulation system according to claim 1, wherein each winding includes turns, the first calculation function further depending on the number of turns of each winding and on the inductances of the isolation interfaces.

11. The regulation system according to claim 1, wherein at least an input voltage port is a bi-directional port.

12. The regulation system according to claim 1, wherein each determination subunit is a subtractor.

13. The regulation system according to claim 1, wherein the safety margin is a predefined value.

14. A multi-active bridge converter with hybrid supply, the multi-active bridge converter comprising:
an input current port comprising an H-shape switch bridge for which a reference switch is defined and operates at a current, the reference switch being called the first reference switch and being controlled by a first control law, the first control law having a first duty cycle,
at least one output voltage port, each voltage port comprising an H-shape switch bridge for which a reference switch is defined, each reference switch being called the second reference switch and being controlled by a respective second control law, each second control law having a predefined second duty cycle and a phase shift with respect to the first control law,
a transformer having windings, each winding being connected to a port by a respective isolation interface, and
a regulation system according to claim 1.

15. A regulation method for a multi-active bridge converter with hybrid supply, the multi-active bridge converter comprising:
an input current port comprising an H-shape switch bridge for which a reference switch is defined, the reference switch being called the first reference switch and being controlled by a first control law, the first control law having a first duty cycle,
at least one output voltage port comprising an H-shape switch bridge for which a reference switch is defined, the reference switch being called the second reference switch and being controlled by a respective second control law, each second control law having a second predefined duty ratio and a phase shift with respect to the first control law,
a transformer having windings, each winding being connected to a port by a respective isolation interface,
the method being apt to regulate the multiple active bridge converter to a setpoint, the setpoint comprising a setpoint current value for the current of the current port and at least one setpoint voltage value for the at least one voltage port, the method comprising the steps of:
measurement of measured values, the measured values comprising the current of the current port and the voltage of each voltage port,
control of the first reference switch, the control step comprising:
a first calculation of a first desired initial value, the first desired initial value being a desired value for the first duty cycle equal to the sum of the result of a first calculation function applied to the setpoint values and of a safety margin,
a first determination of the difference between the measured current value and the setpoint current value, so as to obtain a determined difference of current,
a first correction converting the determined current deviation into a first corrective value for the first duty cycle by applying a first conversion function,
a first addition of the first desired initial value and of the first corrective value, so as to obtain a first candidate value,
a first adjustment suitable for adjusting the first candidate value so as to obtain a first value to be applied between two first extreme values, the first lowest extreme value being the result of the first calculation function applied to the measured values,
a first application of the first control law having as duty cycle the first value to be applied, and
For each voltage port having a set voltage value, controlling the second reference switch of the voltage port considered, each step of controlling the second switch comprising:
a second calculation of a second desired initial value, the second desired initial value being a desired value for the phase shift equal to the result of a second calculation function applied to the first desired initial value,
a second determination of the difference between the measured voltage value for the voltage port considered and the setpoint voltage value for the voltage port considered, in order to obtain a determined difference of voltage,
a second correction converting the determined difference of voltage into a second corrective value for the phase shift by applying a second conversion function,
a second addition of the second desired initial value and of the second corrective value so as to obtain a second candidate value,
a second adjustment suitable for adjusting the second candidate value so as to obtain a second value to be applied between two second extreme values, the second lowest extreme value being the result of the second calculation function applied to the first desired initial value, and
a second application of the second control law having as phase shift the second value to be applied.
